(19) United States
(12) Patent Application Publication
(10) Pub. No.: US 2012/0150077 A1
(43) Pub. Date: Jun. 14, 2012

(54) Intraneural Facilitation

(76) Inventor: Mark R. Bussell, Redlands, CA (US)

(21) Appl. No.: 13/371,103

(22) Filed: Feb. 10, 2012

Related U.S. Application Data
(63) Continuation of application No. 12/953,922, filed on Nov. 24, 2010.
(60) Provisional application No. 61/264,053, filed on Nov. 24, 2009.

(51) Int. Cl. A61H 1/02

(52) U.S. Cl. 601/1

(57) ABSTRACT

A method of relieving pain by manipulation of those parts of a body in order to direct pressurized blood to be brought into contact with ischemic nerves by intraneural facilitation comprising the steps of pressurizing blood vessels proximate to the pain source while performing one or more of the following: stretching the muscles, mobilizing the joints, tractioning the skin, distending the viscera, and distorting the vascular system.

### PRIORITY CLAIM

The present application is a continuation of U.S. non provisional patent application Ser. No. 12/953,922, which claims priority to U.S. provisional patent application 61/264,053, filed Nov. 24, 2009, both of which are incorporated herein in their entirety by reference.

### BACKGROUND OF THE INVENTION

A physical injury may result in chronic inflammation involving the vasa nervorum (CIVN), but the inflammation itself creates a physiological process that outlasts the normal healing process of the original injury. CIVN is an ischemic condition in the vascular system of the affected nerves. Simply stated, in CIVN, the normal blood supplied to the axons of the affected nerves decreases. The nerve then suffers tetany and dysfunction leading to pain over the nerve trunk and on to the associated connective tissue, to joint stiffness and to guarding. CIVN may also have a role in peripheral neuropathy and to the spread of chronic inflammation throughout the peripheral nervous system. CIVN has a variety of causes other than physical trauma, such as diabetes, systemic diseases, kidney disorders, and alcoholism. Symptoms of CIVN are often difficult to diagnose and include sensory loss, muscle weakness and autonomic nerve disturbance along with paresthesias.

The extent of peripheral neuropathy is staggering. The annual cost to Medicare is estimated to exceed $3.5 billion. It has been estimated that 20 million people in the United States suffer from peripheral neuropathy.

There is no systematic way of treating peripheral neuropathy from a manual therapy perspective. This may be because there has not been a way to identify where inflammation is, and to bring blood into all the fascicular mechanisms that restrict blood flow into the fascicles. The only way that blood can feasibly be brought back into the peripheral nerve is to address the intrinsic fascicular mechanisms that restrict the blood flow individually and addressing them through the induction of pressurized blood flow. To date no manual technique has attempted to identify individual mechanisms within the nerve fascicle and to pressurize blood into each of these mechanisms.

### SUMMARY OF THE INVENTION

The present invention is a method for re-vascularizing the nerves subject to chronic inflammation. In particular, it is a non-invasive, non-medication-based, manual technique. Revascularization reverses peripheral neuropathy, reduces time to rehabilitate a patient after joint surgery and reduces, if not eliminates, chronic pain including fibromyalgia.

Inflammation comes to the peripheral nerve and creates a variety of problems within the nerve that can perpetuate the inflammation. Inflammation itself is a healing process but one that can actually perpetuate an avascular or ischemic condition in the peripheral nerve. Trauma is one mechanism that can create inflammation as the immune system tries to repair the connective tissue to the peripheral nerve. Other sources of inflammation may include diabetes, where the capillary walls may actually swell up and occlude the blood flow to the nerve, chemotherapy, or surgery.

After there is initial damage to the neural connective tissue, then there are several physiologic responses that can actually perpetuate ischemia within the nerve. The first physiologic response is swelling in the endoneurial capillaries which may push on their outside blood supply, keeping blood from replenishing the inner fascicle from the normal outside source.

Oedema on the nerves creates pressure on the endoneurium, or outer layer. That pressure in turn puts pressure on the next layer, namely, the perineurium. Because the blood vessels that course from the epineurium to the perineurium flow at an oblique angle, pressure on the exterior of the perineurium shuts off the flow of blood through these vessels.

After inflammation comes into the neural connective tissue, it can creep into sympathetic neural connective tissue resulting in vasoconstriction or tightening of the small arterioles. The result is diminished blood flow into the nerve fascicle due a smaller cross-sectional area within the artery feeding the nerve itself.

When the nerves supplying blood to the sympathetic nerves are themselves deprived of blood, they cannot successfully regulate blood flow to the sympathetic nerves. The result is a self-reinforcing loop: less blood to the sympathetic nerves, less regulation of the blood by those nerves, and therefore less blood to the sympathetic nerves. By supplying more blood to the sympathetic nerves, they are then able to resume effective control over the supply of blood including the supply of blood to themselves. These nerves provide sympathetic enervation locally to their arteries, the same arteries that send blood into the local connective tissue.

In addition the ischemia may affect the sympathetic nerves to the lymphatics in the outermost part of the nerve, thereby affecting the blood flow into the nerve through increased edema. The edema will push on the arterioles again that go throughout the epineurium and perineurium thereby perpetuating the ischemia.

Ischemia spreads with the positive feedback loops described above reducing the total blood flow available to and from other parts of the neurovascular system. This means that there is less blood elsewhere resulting in greater ischemic periods when stress is placed on the neural vascular system.

The Spread of Ischemia As Pertinent To This Invention

1. Onset of ischemia starts initiating and inflammatory process.
2. The inflammation creates swelling around the capillary that cuts off its
blood supply from outside the nerve fascicle.
3. Vasoconstriction of the arterioles occurs due to sympathetic neural
connective tissue inflammation.
4. A slowing of the lymphatics occurs due to sympathetic connective
tissue inflammation creating edema in the outer part of the neural
connective tissue.
5. General ischemia in the neural system spreads as the felt blood loss in
the neural connective tissue creates an inability to replenish blood from
other parts of the neural system. This occurs when stress is placed on the
neural connective tissue with various postures.

In order to re-vascularize an affected nerve, the first step is to identify where the inflammation is in the tissue. The first step towards identification is done by using basic palpation techniques for muscle trigger points and assessing joint end feel. The second part of identification is analyzing the fingers and toes for swelling. The final part of identification is the INFsensory technique to assess where inflamed structures are in the fascicle.

This sensory technique involves and actual mapping that occurs when inflammation enters afferent nerves and proceeds to the cerebellum. The cerebellum provides an alteration of finger muscle tone in conjunction with a specified area of the body that is inflamed. For example the altered thumb muscle tone happens in conjunction with a lack of blood in the mia matre. So if the patient is in a certain position that creates inflammation in the mia matre, then thumb stiffness will reveal both the severity and the location of the inflammation. This technique for identification of the locus of inflammation is unique, a feature of the invention and is described more fully later.

This technique gives the examiner the knowledge of where to initiate the facilitation holds and where to apply the subholds which specifically treat the internal structures that are creating inflammation within the fascicle. Once these steps are taken, the circulation is restored to the targeted peripheral nerve.

The actual facilitation of blood into the neural connective tissue that has been identified as being ischemic occurs when the therapist stretches a joint in three planes. This allows a stretch of the feeder vessel to create a larger opening between the artery and the connecting feeder vessel. This vessel brings pressurized blood (due to more blood entering the feeder vessel from the artery with the enlarged opening) into the neural connective tissue that pushes past the resistance of inflamed tissue. This will be described more fully later in this specification. The facilitation is a critical feature of the invention as it uniquely, consistently moves blood from the arteries to the neural connective tissue which is notoriously absent in disease processes such as peripheral neuropathy and fibromyalgia.

Five specific subholds address critical areas of inflammation within the fascicles. These holds are additional holds used during the facilitation process calculated to restore blood the sympathetic nerves inside the fascicle, the fascicle itself, the neural connective tissue as a whole, the pia metre, and the neural plexus. Stretching is used in conjunction with these subholds to best isolate the nerve that the pressurized blood is being induced to go through. These five subholds are also critical for the introduction of blood within the fascicle and guiding the blood into the inflamed structures that are especially deficient in the identified patient posture.

### BRIEF DESCRIPTION OF THE DRAWINGS

In the figures,

FIG. 1 is diagram showing a peripheral nerve including the connective tissue and vascular system of the nerve;

FIGS. 2A and 2B show blood feeder vessels running from a blood vessel to a nerve when not stretched (FIG. 2A) and when stretched (FIG. 2B) to open them as a result of a facilitation hold;

FIG. 3-5 illustrate the positions of the fingers of a patient with chronic inflammation of the vasa nervoum, with the positions of the fingers indicating the location of the inflammation, in accordance with an embodiment of the present invention;

FIG. 6 is a perspective view of a facilitation hold of the patient's hand and support of the back of a patient to increase blood flow, in accordance with an embodiment of the present invention;

FIG. 7 is a perspective view of the facilitation hold of the hand of a patient to increase blood flow, according to an embodiment of the invention;

FIG. 8 is a perspective view of a mobilization hold with the therapist pushing down on the leg just below the knee to increase blood flow into the nerves that innervate the joint of the knee, that is, the foot is turned outward to expose the nerves on the inner part of the knee capsule to more blood flow in accordance with an embodiment of the present invention;

FIG. 9 is a perspective view of a mobilization hold of a patient's toe, according to a preferred embodiment of the present invention;

FIG. 10 is a perspective view of a hold a patient's ulnar artery to pressurize the neuralvascular system of the patient by bringing blood into the sympathetic neural plexus over the ulnar artery, according to an embodiment of the invention;

FIG. 11 is a perspective view of a patient's head and neck showing skin stretching with the lymphatic sub-hold to enhance the effect of pushing of the skin on the neck inasmuch as lymph nodes are located closer to the spine and the skin, according to a preferred embodiment of the present invention; and

FIGS. 12 and 13 are perspective views of a patient applying the facilitation hold to her wrist while a user applies pressure to her back. The hand placement is over the vertebral process encouraging the bottom vertebra to be held posteriorly and the top anteriorly while the facilitation is according. This is encouraging blood in the microvascular system of the paravertebral plexus that provides innervation and endoneurial capillary blood supply to these areas.

### DETAILED DESCRIPTION OF PREFERRED EMBODIMENTS

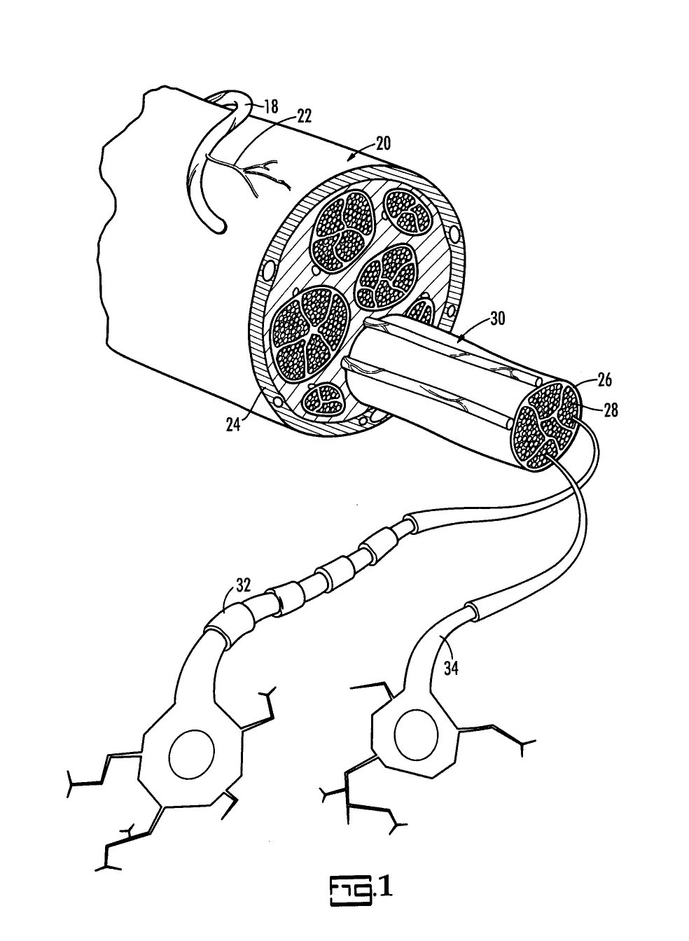

FIG. 1 illustrates the vascular system of the nerves in perspective and partially in cross-section. FIG. 1 shows a nerve 20 having a feeder vessel 22 supplying it with blood from the arteries. The neural connective tissue of the nerve is designed to store blood and ward off neural ischemia and is often described in three parts: the epineurium 24, the perineurium 26 and the endoneurium 28. The epineurium 24 is the outer layer of the nerve 20 and houses many axons thereby providing a “connective tissue framework” for the perineurium 26. Structurally, the epineurium 24 contains collagen and elastic fibrils which run longitudinally to form a sheath that separates nerve 20 from surrounding tissue. The epineurium 24 and its blood are separated from the fascicles 30 and have an extrinsic vascular system while the perineurium 26 binds the contents of fascicle 30, including its axons and their endoneurium 28, where an intrinsic vascular system has been identified.

The perineurium 26 is the middle layer of the neural connective tissue and binds together the endoneurial sheaths. The perineurium 26 surrounds multiple axons and features an inner portion of the surrounding membrane which is multi-layered. The perineurium 26 is formed of flat perineuria cells interspersed with layers of type I and type II collagen fibrils and elastic fibers in circumferential, oblique, and longitudinal orientations. Each layer of perineurial cells has a nearly complete basal lamina. The very organized basal lamina of the innermost layer contains laminin, as well as heparan sulfate proteoglycan and fibronectin. These layers have flat polygonal cells which are joined edge to edge by tight junctions created by the basement laminae. These junctions may be as small as 90 nm. Sunderland notes that there are between 7 to 15 concentric lamellae and this arrangement is remarkably resistant to mechanical trauma. The lamellae are separated from one another by interlamellar clefts lined by mesothelial cells. These are the so-called perineurial spaces which, it is claimed, are in communication centrally with the subdural and subarachnoid spaces. The lamellae are joined across the clefts by oblique anastomosing fibers.

The perineurium 26 does not present a sharp delimitation from epineurium 24. However, internally, it is sharply separated from the contents of the fascicle 30. Externally the perineurium 26 merges with the epineurium 24 without any abrupt line of demarcation. Internally, however, it presents a smooth surface sharply separated from the contents of the fascicle 30 except where fine fibroblastic processes or septa pass internally to blend with the endoneurium 28. This inner, smooth surface is formed by a membrane, composed of flattened polygonal mesothelial cells, one to two layers in thickness, which is easily distinguished from the collagen fibers of the perineurium 26. This membrane, which can be identified as a special part of the perineurium 26, is the perilemma and it provides the morphological basis of the diffusion barrier action of the perineurium 26. Perineuruial cells show high activity of different dephosphorylating and oxidative enzymes, and adenosine triphosphate has been demonstrated in micropinocytotic vesicles as well as in the basement membrane of the perineurium 26. The perineurium 26 acts as a metabolically active diffusion barrier.

The endoneurium 28 forms the supporting matrix for non-mylinated 32 and mylinated axons 34. The endoneurium 28 is the delicate, closest layer of connective tissue to the nerve axons 32, 34, and forms a thin external limiting membrane about each nerve fiber. Each nerve fiber is enclosed in an endoneurial sheath made of collagen fibers. The endoneurial cells form fine septa which subdivide the contents of the fascicles into smaller sections. These septa contain the collagenous tissues that are arranged longitudinally and form the supporting wall of the endoneurial tube. There are no lymphatics in the fascicles 30, a circumstance that has potentially significant pathological consequences.

Neural circulation starts with nutrient feeder vessels 22 arriving along the course of the nerve 20. These nutrient feeder vessels 22 bifurcate once inside the epineurium 24, but before reaching the nerve, into ascending and descending braches and display anastamoses in all directions. The capillaries are continuous with post-capillary venules whose diameter ranges from 13.9-27.8 μm and whose length ranges from 60.0-200 μm. Wide, thin-walled venules are found within the epineurium 24 and perineurium 26, and often veins are paired with arterioles. The vascular vessels vary in type and sizes in the epineurium 24 but with the venular vessels significantly predominating over the arterioles in the epineurium.

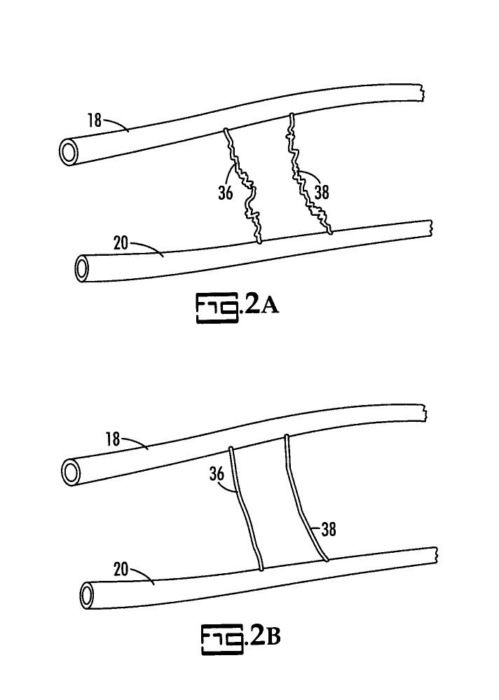

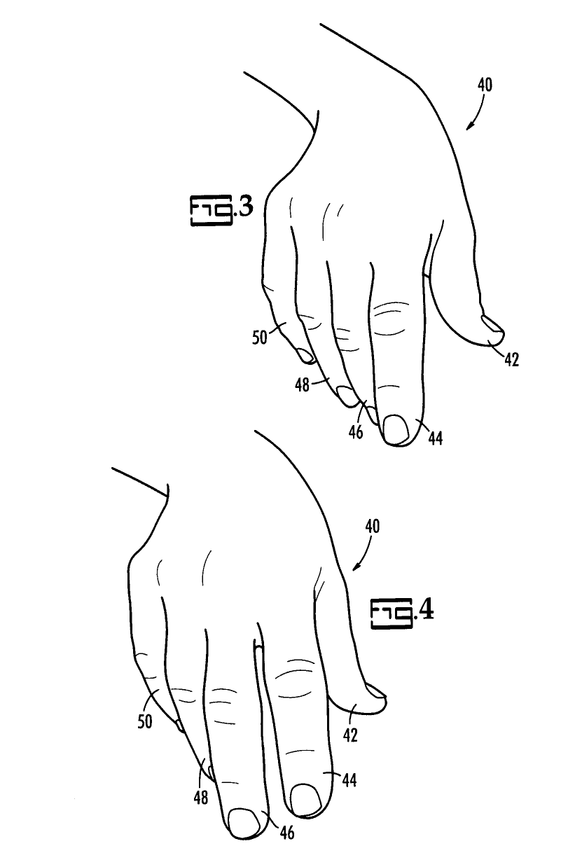

While nutrient feeder vessels 22 are found throughout the nerve 20, they are often around joints with a large feeder vessel located proximal to the ankle. See FIG. 2A. The anatomy of the nutrient vessels includes arteries 36 and veins 38 in a coiled fashion moving from an artery 16 to the neuro-vasculature accompanying a nerve 18 close by. This is significant for the facilitation technique in how it pressurizes blood into the nerves as these are the vessels that distorted as shown in FIG. 2B, with the facilitation hold and enabled to bring blood into neural connective tissue with increased pressure.

The epineurial vessels communicate directly with vessels in the deep layers of the nerve as well as with regional vessels that provide support for the epineurial vessels. Transperineurial vessels pierce the perineurium from the epineurium and communicate with the capillaries in the endoneurium carrying a short sleeve of perineurial cells. Due to the frequent communication from the transverse anastamoses feeder vessels and the regional feeder vessels, blood flow varies at almost every branch. The interconnectedness of the vessels, the superficial nature of the connective tissue, its relationship to the feeder vessels, and its ability to reinforce the intrafascicular blood flow are all important characteristics of the epineurium. There is a lymphatic capillary network in the epineurium that is drained by the lymphatic channels that accompany the arteries of the nerve trunk and that ultimately communicates with the regional lymph nodes.

The vascular anatomy of the perineurium includes a vascular plexus which forms a capillary bed in which there is no preferred direction of the blood flow. This vascular plexus has a close relationship with the intrafascicular endoneurial capillary bed. In the presence of oedema, there appears to be a valve type mechanism based on the transperoneal vessels that pierce the perineurium. This occlusion occurs in the presence of endoneurial oedema as pressure is placed on the perineurium.

The transperineurial vessels are significant as they are the vessels that are often occluded and keep the blood from flowing from the outside of the nerve fascicle to the inside of the nerve fascicle. This issue is addressed by the “joint mobilization” subhold which is described later on.

The vascular anatomy of the endoneurium includes a capillary network which has a closed vascular relationship to the perineurium. The endoneurial capillary network is mostly parallel to the nerve, but sometimes runs obliquely to the nerve. The capillaries in the endoneurium have great reserve capacity in part because they are larger then muscular capillaries (6 to 10 um verses 3 to 6 um). Blood flow direction in individual endoneurial vessels may change immediately when even slight compression is applied to the surface of the nerve or when a regional extrinsic vessel is damaged. It has been shown that proteins easily pass through the walls of epineurial blood vessels, while there is normally no leakage or minimal leakage of proteins through the walls of endoneurial microvessels. In endoneurial capillaries, the endothelial cells are extremely closely opposed, forming so-called tight junctions, the ultrastructure of which is analogous to corresponding phenomenon between perineurial cells.

The endoneurial capillary system is significant as with inflammation it can cut off its own blood supply from the nerve and can prevent blood from entering the nerve through the resultant pressure placed on transperineurial vessels. Additional description are provided below.

Sympathetic nerves are found through the neural connective tissue in all layers except the closest layer. The sympathetic fibers innervate the lymphatics that are found in the outermost layer of the neural connective tissue and are responsible for removing excess swelling from the nerve fascicle.

Sympathetic nerves also function to innervate the smooth muscle of arterioles which are part of the neural vascular plexus coming from arteries.

The sympathetic system is important and its influence on the neural microvascular system can be addressed in two subholds: The first is the lymphatic subhold, and the second is the arteriole subhold. Inflammation of the sympathetics results in vasoconstriction and decreased blood flow due to excessive arteriole muscle tone.

Sympathetic inflammation in the lymphatic system around the nerve also creates a decrease lympathic productivity resulting in increased swelling around the nerve with decreased protein and fluid uptake.

| Anatomical and | | |
|---|---|---|
| Physiologic | | How addressed with |
| Feature Identified. | Why Important | Technique |
| Location of feeder | Located around joints | Wrist and Ankle joints |
| vessels | primarily | used to distort feeder |
| | | vessels with holds and |
| | | promoted increased |
| | | blood flow pressure. |
| Transperineurial | Cut off blood from extra- | Through mobilization |
| vessels | fascicular compartment to | of a joint (pushing one |
| | the intra-fascicular | bone on another) and |
| | compartment | pressurized blood flow |
| | | the blood is allowed to |
| | | push through these |
| | | vessels and return |
| | | extrafascicular blood |
| | | flow to intrafascicular |
| | | blood flow. |
| Endoneurial | Create oedema that keeps | Blood flow restored |
| capillaries | blood from coming through | through the |
| | the capillaries (upstream) | combination of |
| | and into their capillaries | facilitation and |
| | from transperineurial | a subhold. |
| | vessels | |
| Sympathetic | Inflammation associated | Decreased symphatic |
| nerves in the | with these nerves creates a | inflammation |
| epineurial fascicles | slowing of the lymphatic | associated with a |
| lymphatic system | system's ability to carry | subhold |
| | away proteins and swelling. | |
| Sympathetic | Inflammation associated | Decreased fascicular |
| nerves in the | with these nerves creates a | inflammation with |
| epineurial and | decreased pressure in the | these nerves in the |
| perineurial | nerve fascicles with | arteries due to an |
| connective tissue | vasoconstriction due to | arteriole subhold. |
| | nerve tetany. | |

Certain types of pain, namely, those associated with neural inflammation, are characterized by restricted or halted blood flow to the nerves. These types of pain are typical in chronic pain patients, patients with peripheral neuropathy or with sciatic nerve pain, those who have persistent pain from old injuries, carpal tunnel pain, asthma, and post surgery involving nerve trauma.

Without wishing to be bound by theory, it is believed that chronic inflammation of vasa nervorum (CIVN) can be spread according to the following model after certain injuries, particularly when multiple feeder vessels have been damaged and their ability to deliver blood to tissues has been compromised as a result of that injury.

Initial oedema is formed in a capillary or a capillary bed, potentially due to an initial physiologic process or mechanical insult. The capillaries downstream of the injury are deprived of blood because of swelling in the damaged capillaries. Due to the general anoxia and swelling of the endothelium local to the injury, swelling then spreads out from there. The injured person's Immune responses further create a blocking or “damming” affect as they unsuccessfully attempt repairs at the site of injury. The failed immune system efforts result in macrophage proliferation, neutrophil aptosis, and fibroblast proliferation with adhesions.

The distal site, which has now also become ischemic, will also begin to receive immune system support, triggering the start of chronic inflammation. Adhesions and increased fibrosis decrease axonal mobility thereby contributing to a “double-crush” distally along the axon. The distal capillary basement membrane thickens causing endothelial hyperplasia along with the CIVN. The distal endoneurium thickens and its permeability increases as well as the uptake of ICAM-1.

The affected nerves become hypersensitive because of ischema and CIVN progresses as a matter of course. Meanwhile, a positive feedback loop ensues even after the outwards signs or the initial injury has been resolved, with downstream inflammation resulting in ischemia secondary to that upstream.

Thus, through the formation, as noted above, of a series of micro-compartmental, edematous capillaries, an environment of progressive nerve excitability and inflammation develops. Inflammation, fibrosing, micro-compartment syndrome, edema, neural excitability—are all possible according to the foregoing model. This model demonstrates how CIVN may spread from an initial injury to create inflammation with idiopathic peripheral neuropathy (PN).

Heretofore, no manual technique has been shown to be effective in reducing neural inflammation through reintroduction of blood into the peripheral nerve.

Yet there is speculation that certain types of manual treatments may be effective in decreasing endoneurial edema, which would be the first goal of revascularization of the neural connective tissue. It has been hypothesized that nerve gliding techniques can have a positive impact on symptoms by improving intraneural circulation, axoplasmic flow, neural connective tissue viscoelasticity, and by reducing sensitivity of AIGS. Speculation exist that joint mobilizing creates neural modulation potentially through sensory nerve excursion involving a direct pull on the motor end plate and nerve axon, while the more pliable neural connective tissue is more stationary and does not react as quickly to an excursion placed on the nerve connective tissue through the mobilization force.

However a closer look at the published anatomy and the observations by researchers may reveal why manual therapy techniques have not gotten even so far as a pilot study for evaluating their ability for symptom alleviation. Inherent challenges in the neurovascular tissue that would preclude manual techniques from providing consistent peripheral neuropathy symptom relief include the neurovascular connective tissue blood reservoir having an insufficient reserve capacity.

Some anatomical and physiological observations of the endoneurial capillary complex have led medical researchers to conclude that the endoneurial capillary functions as a part of a large reservoir necessary to avoid system-wide ischemia. Bell and Weddell reported that the endoneurial capillaries are 2.5 times bigger than their musculo-skeletal counterparts and appear to be part of a system-wide in situ reservoir. In essence, the capillary would not only hold blood for itself for local nutrition and for carrying away waste products for its axon, but also to contribute to the system-wide blood reserve for regions that are subject to ischemic conditions. Bell and Weddell also state that the design of the neural connective tissue vascular complex enable a relatively constant volume of blood to move through large conduits but which could then be rerouted.

Bell and Weddell also point out that one factor that may be a part of the reservoir function of the endoneurial capillaries is the multi-directional flow pattern of the blood within the endoneurial capillary network. The multi-directional blood flow enables the reserve portion of the capillary blood to replenish an ischemic capillary region, indicating a viable mechanism for a blood reservoir to be administered where needed. Lundborg describes complex flow patterns through the neural connective tissue and states that different flow directions were encountered simultaneously at different points along a given vessel as a result of anastomotic links. He also says that the direction of flow was also seen to reverse in response to trauma or sympathetic stimulation. Bell and Weddell, in describing the neurovascular system, state that the design of the neural connective tissue vascular complex enables a relatively constant volume of blood to move through large conduits and be easily rerouted.

It would seem that seem logical that for the entire neurovascular system to function as a reservoir for itself, and that there would have to be a clear connection between the endoneurial and pia matre capillaries. This free flow of capillary blood throughout the extremities into the pia matre and back into the extremities would enable reserve blood from other regions (limbs, for example) that are not being subject to temporary ischemic stress to flow into general areas (other extremities, CNS, for example) where strain or ischemia were occurring. Indeed, a regional restriction (such as blood staying in the extremity) on capillary blood flow would seem to negate the reservoir function of the large endoneurial capillaries and the neurovascular system at large. It would, in essence, prevent the blood from transferring over to ischemic areas to reinforce the anastomotic blood reserve in an area where circulation was markedly diminished. Some research evidence does indeed indicate that there is such a connection between the capillaries of the peripheral nervous system and those of the central nervous system. A congruous connection between the endoneurium and the pia matre is described by Sunderland and is further evidence of a system-wide capillary network for bringing blood to all parts of the system as a whole.

In a study by Matzke, a series of experiments was performed that included the tetanus toxin being injected into the endoneurial space in rats. The tetanus toxin was observed being carried centripetally to the brain, leading the researchers to state that the endoneurial tissues' spaces serve as a conduit for tetanus toxin to travel from the muscle to the central nervous system. The most logical path along which to transport the toxin in the endoneurium would be the resident capillaries, and the transportation of toxin between the PNS and CNS in this capillary complex is what these researchers may have been observing. This study, along with Sunderland's findings regarding the close connection between the pia matre and endoneurium points to the possibility that the entire neurovascular circulatory system at its deepest level (endoneurium and pia matre capillaries) is a vast reservoir and canal system through a connected capillary complex existing between the CNS and peripheral nervous system.

Theoretically, some techniques may mobilize sensory or motor axons and potentially have an impact on the neurovascular environment locally but will have limited impact on improving the blood flow in the capillary network at large. Cervical mobilization, for instance, may increase local blood flow capacity by improving the endoneurial blood flow in the cervical nerve root, however the impact on a whole-system ischemic condition may be transient with the duration of the technique generally being short and the mechanism potentially being one of a local, physical nature.

The endoneurial thickening created by inflammation may only be aggravated by certain manual approaches that strain or stretch the neurovascular connective tissue. Compression to the nerve and its connective tissue was studied extensively by Lundorg and shown to create endothelial swelling within the endoneurium. Strain was also evaluated closely in a series of experiments under which oedema was created. Repetitive stress injuries such as carpal tunnel are another example of mechanical trauma that results in oedema. Mechanical trauma thus may create neurophysiological events in which reduced endoneurial blood flow leads to peripheral neuropathy symptoms.

The manual technique is unable to move the blood past the perineurium into the ischemic endoneurial region. As noted earlier endoneurial swelling is associated with thickening of the perineurium and endoneurium. The transperoneal vessels come through the perineurium where a valve mechanism could potentially exist. As the transperoneal vessels are the only communicating vessels between the extrafascicular and the intrafascicular neurovascular compartments, an occlusion of the transperoneal vessels would impair communication between the extrafascular and intrafascicular vasculature. Oedema has been identified as a potential agent for occluding the transperoneal vessels by increasing the pressure on the perineurium. The transperoneal lumen, due to oedema-created perineurial thickening, could be signally deleterious to the vascular compensatory properties of the neurovascular tissue perhaps significantly, creating a positive feedback loop for additional ischemia and oedema throughout the course of the nerve.

Decreasing the oedema in the nerve fascicle sufficiently to remove the pressure on the perineurium and to then allow blood to pass through the transperoneal vessels or to force blood through the occluded transperoneal vessels would seem to be the first priority for a manual technique attempting to reintroduce blood into an ischemic nerve. Yet the ability to identify the ischemic areas of the nerve would seem difficult even to the experienced manual clinician. Being sure that the right perineurial valves have been opened and that sufficient blood has been allowed to flow into the nerve would seem beyond the scope of most manual techniques. Myofascial release, for instance, may reduce the strain on the extrafascicular compartment of the nerve, but extrafascicular relief from pulling connective tissue would not seem to have a significant impact on the intrafascicular structure. The extrafascicular oedema might temporarily abate, but this technique would seem likely to have little effect in combating existing oedema in the endoneurium with the transperoneal valves throughout the nerve remaining closed due to increased Endoneurial pressure.

The inability of blood traveling through nutrient vessels from accompanying arteries is not addressed by the manual technique. Nutrient vessel dysfunction has been identified as markedly abnormal with diabetic patients who have painful neuropathy. Nutrient vessel dysfunction or even sectioning of a single nutrient vessel may not immediately slow the endoneurial circulation; however a progressive occlusion of nutrient vessels will eventually create a vascular insufficiency along the course of the nerve. Lundborg noted that when sectioning nutrient vessels over the course of the rabbit sciatic nerve, complete intraneural stagnation occurred between 7.5 cm. and 9.5 cm. His conclusion was that in order for the intraneural blood supply to be adequate, the nearest functioning regional or feeder vessel was to be no further than 9.5 cm away. The complexity of coaxing blood from a nearby artery into an occluded nutrient vessel and ensuring the observed nutrient vessel remains patent maybe beyond the scope of modern manual techniques. Yet for a manual technique to be effective in reintroducing blood into the ischemic nerve, the ischemic feeder vessels would have to be addressed by some aspect of a manual technique to ensure the critical limit as identified by Lundborg is met.

| Ways That | | |
|---|---|---|
| Blood Flow To | | |
| the endoneurial | | Why It Is Important |
| capillary Is | What Caused This | for the Ischemic |
| Restricted | Physiologic Problem | nerve |
| 1. Decreased | Multiple trauma, | No compensatory blood flow |
| total blood in | autoimmune, | available in various positions. |
| the Endoneurial | combination of | No way to provide accessory |
| capillary system | factors | blood needed in case a |
| all over | | nerve has temporary ischemia |
| 2. Sympathetic | Back, lymphatic | Decreased blood pressure |
| vasoconstriction | irritation, local nerve | (hose is tightened) to the |
| | irritation associated | nerve from arterioles |
| | with inflammation to | |
| | sympathetics | |
| 3. Sympathetic | See #2 | Swelling around nerve |
| lymphatic | | fascicle pushing on |
| inflammation | | fascicle |
| 4. Immune | Chronic edema in | White blood cell blocking |
| driven neural | the nerve fascicle, | or occluding Endoneurial |
| inflammation | genetic, virus, food | capillary |
| | allergy | |
| 5. A local | General blood flow | Insufficient blood pressure |
| swelling in the | lack within the | to force through the |
| nerve creating | nerve, not | swelling and local |
| endoneurial | necessarily related | nerve ischemia |
| inflammation | to sympathetic | |
| which is not | vasoconstriction. | |
| addressed by | Potentially due to a | |
| the immune | local injury | |
| system properly | | |
| 6. Local | Endoneurial | Ischemic problems of |
| swelling in the | oedema | the entire nerve are multiplied |
| nerve creating | | as the blood is not allowed |
| transperineurial | | to be carried from outside |
| vessel | | the neural connective tissue |
| occlusion | | to the inside of the |
| | | neural connective tissue |
| 7. Inflammation | Hip or shoulder | A variety of sympathetic |
| associated with | capsule | and arteriole symptoms |
| the neural | inflammation next to | to the affected extremity |
| plexus or | the cervical and | that has the plexus |
| “plexopathy” | lumbar plexus, | inflammation only. |
| | general sympathetic | |
| | inflammation | |
| | working it's way | |
| | down into the neural | |
| | plexus | |

To correct the aforementioned anatomical limitations, the practitioner would theoretically utilize a technique that addressed the limitations specified above. The technique would presumably need to be specific enough to address local nerve inflammation while having the potential to address ischemia generally, and to strongly enhance the global endoneurial reservoir. The technique would need to be indirect to avoid manual compression of the neurovascular tissue and avoiding further endoneurial compromise. It would also need to create sufficient neurovascular capillary pressure to push blood from the extrafascicular compartment, past the perineurial valve mechanism created by the endoneurial oedema, and into the endoneurial capillaries. Finally, it would have to improve the blood flow through the failed nutrient vessels to ensure these vessels are patent. In this way, the positive effects from the manual treatment will continue in terms of intraneural blood flow and the critical limit of 7.5 cm to 9.5 cm from the nearest regional feeder vessel will be met.

The technique would have to be three fold: First to identify what type of inflammatory process is occurring. The second part of the technique would be to facilitate a pressurized blood flow to the nervous system. The third part of the technique would be to utilize subholds to address the unique nature of each of the inflammatory processes described above while monitoring the blood flow to the affected tissue structure (transperineurial nerve occlusion, sympathetic vasoconstriction, plexus inflammation, etc).

Below is a table that describes the three step process for treating neural inflammation. The sensory technique is the first technique, but it is done throughout the treatment process to determine the status of the blood flow in the nerve while the treatment is continuing.

Three parts of revascularizing the peripheral nerve

1. Identifying where the inflammation is and the unique structures that are
inflamed within the nerve (sympathetics, transperineurial occlusion,
endoenurial oedema, etc)
2. Pressurizing blood flow to the nerve
3. Providing a subhold, which serves as a valve mechanism that enables
the blood to flow into the inflamed connective tissue of the affected
structure.

The First of the three steps of re-vascularizing the peripheral nerve is identification of the inflamed structures that are in the peripheral nerve and that are affecting the peripheral nerve. This identification process is crucial for selecting the subholds that will be used along with the facilitation.

5 Steps to Identification of Neural Inflammation, Including What
Structures Are Inflamed Within The Fascicle (Sympathetic nerves,
Arterial nerves, Endoneurium, etc)

1. Palpate muscles of patient in the sitting position to assess for trigger
points
2. Palpate general viscera and assess for swelling and tenderness with
patient in the supine position
3. Initiate assessment to see the extent of the swelling around the fingers.
If the finger position among all fingers is not held in the same place by
the swelling, it is time to do the INVF sensory assessment.
4. Start the INVF sensory assessment. If swelling or lack of swelling is not
a factor with normal circulation, repeat gentle pressure on proximal
phalange and assess cerebellar input into the fingers and toes to provide
a guide as to where the inflammation is most resident in the structures
affecting the nerve you are assessing (sympathetic, endoneurium, plexus,
arteries, meninges). A description of the identification technique follows.
5. Choose your subholds based on the sensory technique. The technique
assesses only the structures within the immediate vicinity of and affecting
the nerve in the position the patient is in (lying, sitting, standing,
sidelying, etc). See below.

The Followings is a detailed description of the basic observations that a therapist will make while identifying where the nerves that may be severely inflamed in the body.

There are basic observations and palpation principles that should help the clinician in identifying in the hands and feet what symptoms of neural inflammation maybe present.

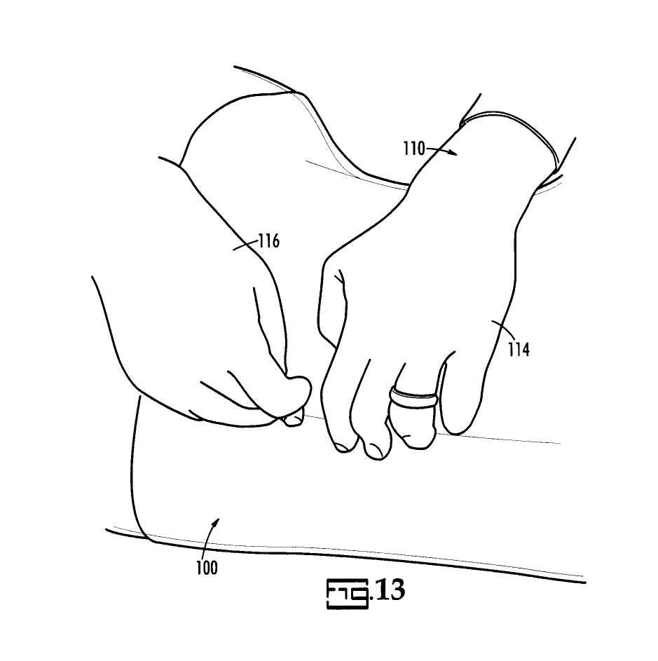

1. General palpation of trigger points (or muscle knots) of the patient in sitting. Tight, fibrosed and hypersensitive areas are indications of nerve axonal inflammation and muscle guarding and a decreased nerve firing threshold. These nerves need to be assessed in the appropriate position that stretches the nerves in conjunction with the INF to see what structures are creating the neural inflammation trigger points. Palpation of trigger points and muscle tightness may take place while lying down. This palpation may include the hamstrings, quadriceps, and low back musculature in prone (as illustrated in FIGS. 12 and 13). Inflammation of any muscle group may indicate inflammation within a peripheral nerve (suprascapular nerve if a trigger point is located there) leading the educated examiner to conclude that inflammation may also be associated with the dorsal scapular nerve and C5 due to the proximity to the suprascapular nerve. Trigger points on the rhomboids, the muscle group that is associated with the dorsal scapular nerve, would confirm the examiner's initial diagnosis. Again, additional trigger point knots need to be assessed with the INVF sensory technique to ensure that all the structures are treated with the facilitation hold and a subhold to ensure that all the structures are addressed which created the inflammation and resulting muscle knot. FIGS. 12 and 13 show a representation of both the primary facilitation hold of the patient's right hand 90 by the patient 100 herself to increase pressure and volume of blood into the closed neural connective tissue system, while a subhold is performed by the therapist 110 that biases the pressurized blood in the neural connective tissue to flow into the endoneurial capillaries from outside the fascicle near the paravertebral ganglion at the small of the back 112. In the subhold (best seen in FIG. 13), the therapist 110 is bent over the patient 100 and his left hand 114 pulls the spinous process upwards while the right hand 116 pulls the caudal spinous process downwards. This subhold, together with the facilitation hold applied by the patient (best seen in FIG. 12) urges blood flow into the paravertebral ganglion microvasculature.

2. General Visceral palpation—This take practice but abdominal bloating is splanchnic nerve inflammation with swelling from the myriads of sympathetic nerves innervating the abdominal viscera. A gentle palpation of the stomach of an individual with quick recoil and immediate patient sensitivity would indicate that the patient has greater thoracic splanchnic inflammation which can back up to T5-10 vertebra. Inflammation in the viscera can lead to arterial inflammation that can spread through a connected neural plexus into the peripheral nerves. Furthermore, endoneurial inflammation in the sympathetic nerves deprives the entire endoneurial system of compensatory blood rendering the peripheral nerves to have longer periods of ischemia if stretched.

2. Skin feeling—While not mentioned in the table above skin palpation “feeling” is still important. Neural inflammation maybe created from systemic or endogenous conditions such as Celiac's disease or diabetes. If the skin is excessively dry or flaking, a local or system allergy maybe a contributor to generalized mast cell depolarization. A normal skin feel which is soft and not dry may indicate that this has not occurred. This may indicate autoimmune involvement in neural inflammation.

2. Skin color—Skin color is also important and can be an indicator of neural inflammation. Pale skin color in the distal extremities may indicate a lack of normal capillary involvement. The practitioner may be suspicious of sympathetic vasoconstriction potentially due to prevertebral ganglia inflammation, distal nerve trunk inflammation with sympathetic construction around local blood vessels and arterioles or both (Raynaud's syndrome).

After a general palpation has been done to actually identify where the nerves are that are inflamed, it is important to examine the fingers and the toes. We are progressing towards the INVF sensory test, but first we have to look at the edema around the fingers and the toes, which have nerves that are close to the skin and swelling is not hidden. The swelling of the deeper nerves of the thigh, the shoulder, the torso or the forearm are all hidden by accommodating tissue. Furthermore if there is swelling, the examiner may attribute to a joint or muscle problem. Please see the table below:

Identification of neural Inflammation before and during the INVF sensory
test

| | Finding | Conclusion | Your response |
|---|---|---|---|
| 1. Identify | All fingers | Severe oedema in | 1. Initiate vascular |
| status of MP | symmetrically | all fingers with | treatment (with |
| supported | outstretched | general neural | facilitation and |
| swelling | and swollen | inflammation in the | vascular subhold) |
| | | nerve with the | to improve |
| | | fingers providing | microvascular |
| | | the most obvious | circulation. |
| | | clues to the | 2. Watch hand for |
| | | inflammation. | a variance in |
| | | | finger position and |
| | | | reduced girth, |
| | | | overall swelling. |
| | | | 3. Start INVF |
| | | | assessment |
| | All fingers | No microvascular | 1. Initiate vascular |
| | symmetrically | circulation to | treatment (with |
| | down with no | provide any normal | facilitation and |
| | real girth | fluid to assist | vascular subhold) |
| | (fully flexed) | the joint with | to improve |
| | | normal tone. | microvascular |
| | | | circulation. |
| | | | 2. Watch hand for |
| | | | a variance in |
| | | | finger position and |
| | | | increased girth, |
| | | | and better joint |
| | | | effusion. |
| | | | 3. Start INVF |
| | | | assessment |
| 2. INVF | Now that | Present finger | 1. Initiate |
| assessment | swelling has | position can | treatment using |
| | cleared the | provide information | subholds that |
| | muscle tone | to the presence | correspond with |
| | and finger | of inflammation | the findings of the |
| | position can be | within the nerve | INVF assessment. |
| | assumed to be | fascicle and | |
| | from the | the structures | |
| | cerebellar | affecting the | |
| | response to | nerve fascicle | |
| | the afferent | | |
| | nerves input | | |

As noted in the table the swelling may act like a splint while keeping the clinician from pushing on the distal phalange and getting a true feel of the muscle tone or decreased muscle tone present and keeping the therapist from performing the INVF sensory test. Or the lack of normal fluid in the tissue space along with a decrease in responsiveness by the surrounding muscles due to inflammation may keep the therapist from getting any meaningful muscle tone assessment as all MP joints just “bottom out”.

As noted in the table the best way to eliminate the swelling that will affect the INVF sensory test is to perform a facilitation hold (described below) and a vascular subhold (described below). These two holds will reduce the swelling in the hands or increase the blood flow in the hands and feet sufficiently so that the examiner may utilize the INVF sensory test.

After the clinician has normalized the blood flow to the hands' microvasculature, the joints will be able to respond to cerebellar modifications of muscle tone being free of the splinting oedema and having sufficient blood flow in the surrounding neural microvasculature.

The clinician is ready to initiate the INVF sensory test (the sensitive test) needs a more normal tissue fluid to be sensitively provide cues for inflammation in the nerve fascicle and in the structures that affect the nerve fascicle. This test is very sensitive to vascular change within the neural microvasculature system in the position that the patient is in. Not only is it sensitive to change of blood circulation but it will alert the trained clinician as to the location of the primary areas that need to be treated (arterial vs. plexus vs. prevertebral sympathetic vs. paravertebral sympathetic, vs intrafascicular oedema, UE vs. LE). This sensory test will also alert the clinician when the treatment has accomplished the goal of restoring endoneurial capillary blood flow.

Please see the following table for key components of the INVF sensory test:

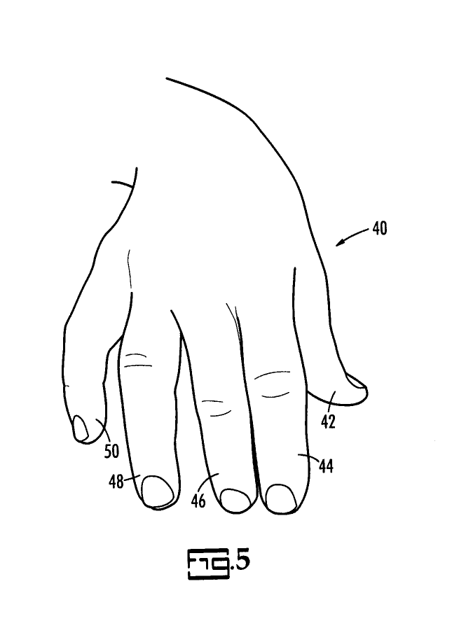

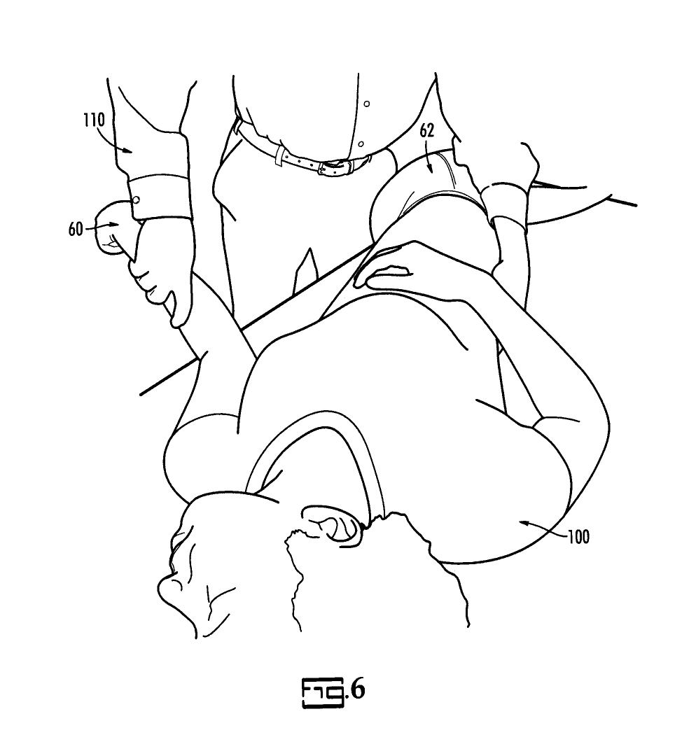

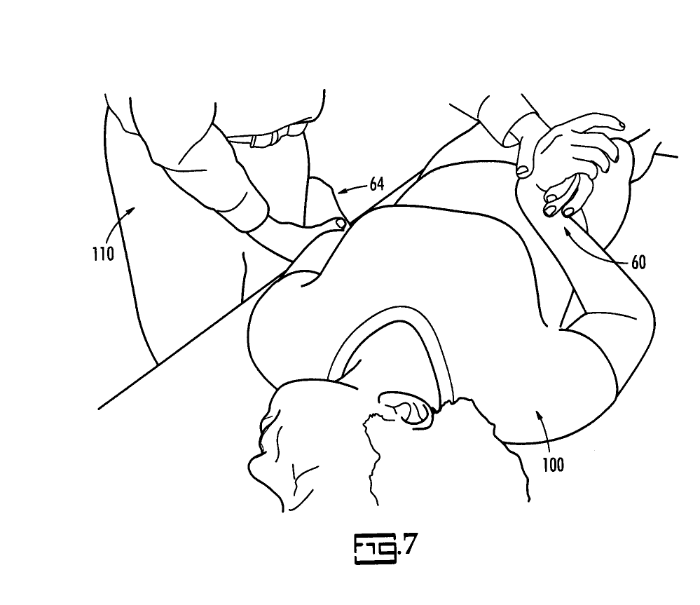

Muscle tone dysfunction is tested by simply pushing down gently on the proximal phalange and feeling both the resistance (the degree the Metacarpal Phalangeal (MP) joint wants to recoil to its original position) and watching the quality of the range of motion of the joint. The treating clinician will support the wrist of one hand 40, as seen in FIGS. 3-5, while viewing the fingers 42, 44, 46, 48, 50, and testing the affected finger (pushing the MP joint gently through the range) while having the patient lie flat. To start treatment, all fingers and toes are assessed and this assessment may be continued throughout the course of the treatment while the patient is in the base position, lying flat on his back.

Key Components of the INVF Muscle Tone Test For Fingers and Toes
And What This Test Tells The Practitioner

1. Each finger is mapped to and controlled by the cerebellum
2. The response of the finger being pushed down and assessed for
dysfunctional muscle tone indicates the severity of inflammation in that
particular aspect of neural fascicular ischemia assessed. The worse the
finger muscle tone, the worse the neural feedback to the cerebellum is
and the greater the ischemia from structures that finger represents.
3. The finger affected and determined to have dysfunctional muscle tone
indicates an area of the nerve fascicle that needs to be addressed with both
the facilitation and a particular subhold.
4. The practitioner now knows that in the position that creates a
“stretching of the nerve” which components of the nerve fascicle are
inflamed and the degree of inflammation.
5. The practitioner can monitor the resolution of the dysfunctional muscle
tone in the affected toe or finger while administering the correct subhold
with the facilitation treatment.

Muscle tone is specific to each finger and modifiable with treating the areas that correspond to the finger that is inflamed (see following table and refer to FIGS. 3-5). Muscle tone does improve with INVF in the second finger, for instance, if inflammation is reduced in the area that the second finger is cueing, that area is inflamed. Two charts illustrate this point. The first chart illustrates the severity of inflammation based on the type or degree of dysfunctional muscle tone.

| Muscle Tone | |
|---|---|
| Dysfunction | |
| Grades | Muscle Tone Dysfunction With Description Severity scale |
| Grade 0 | Normal tone |
| Grade 1 | Beginning of neural in affected area. Early hypermobility |
| | followed by normal tone. |
| Grade 2 | General hypermobility with end range stiffness. |
| Grade 3 | Initial hypermobility with stiffness throughout the entire |
| | range. |
| Grade 4 | Stiffness throughout the whole range of the MP or IP joint. |
| Grade 5 | Complete spasticity for finger. |

Grade 0 represents normal muscle tone. In the case of normal muscle tone, there is no stiffness or problems associated with the passive range of motion (PROM) of the first metacarpal phalangeal (MP) joint (the joint most easily assessed). Grade 1 represents the beginnings of neural ischemia in the affected body segment and is identified by early hyper-mobility of the joint followed by normal tone and then a stiff end feel. Grade 2 represents hypermobility of the finger's MP joint from neutral ischemia until the finger hits end range stiffness. Grade 3 represents hypermobility initially then stiffness throughout the entire range of the finger's MP joint. The absence of tone control indicates severe inflammation. Grade 4 represents severe stiffness with little available range with gentle downward pressure of the MP joint. Grade 5 would be a complete lack of motion and complete stiffness in the finger.

Muscle tone improves in the finger as blood comes through the affected nerve and revascularizes the inflamed areas that the finger muscle tone represents to the cerebellum. When the muscle tone improves from grade 3 or 4 to grade 0 or 1, the treatment is complete and blood is back in the endoneurium of the targeted segment. Again, this improvement in muscle tone is extremely important while performing the facilitation with a subhold as the practitioner can see the improved muscle tone and know the blood is being restored to the afferent nerves that are ascending to the cerebellum.

The second part of the INVF sensory technique is to assess what structures are inflamed within the nerve. This will again be useful both with understanding the pathology that is affecting the nerve and choosing a subhold to perform while addressing the neural ischemia with the ischemic technique. Here is a table that identifies the structures that correlate with finger and toe muscle tone in a specific position.

Chart for Sensory Technique - Which Finger Correlates With Which
Structure Contributing to Peripheral Nerve Inflammation

| Toe or | | Mode of | Which subhold |
|---|---|---|---|
| Finger | Area Represented | Inflammation | to consider |
| First Toe or | Pia Matre Capillaries, | Pia Matre | Primarily |
| Finger 42 | Sympathetic afferent | Capillaries | positional |
| | reportig to cerebellum | within Meninges | subholds |
| Second | Presympathetic | Primarily the | Lymphatic |
| Toe or | ganglia sympathetic | lymphatic | subhold or |
| Finger 44 | afferent reporting to | sympathetic | vertebral, |
| | the cerebellum | nerves | sacral |
| | | | subhold |
| Third Toe | Parasympathetic | Neural plexus | Arterial |
| or Finger | ganglia sympathetic | around arteries | subhold |
| 46 | afferent reporting to | going to | |
| | the cerebellum | neural arterioles | |
| Fourth Toe | Plexus assessed | Primarily | Joint |
| or Finger | (lumbar cervical, | preverertebral | mobilization |
| 48 | coccyx, sacral) | sympathetic | subhold in |
| | sympathetic afferent | nerves or | combination |
| | reporting to the | cutaneous | with low |
| | cerebellum | nerves | lumbar, |
| | | | cervical or |
| | | | sacral, coccyx |
| | | | mobilization, |
| | | | shoulder or hip |
| | | | mobilization |
| | | | with joint |
| | | | mobilization |
| | | | subhold |
| Fifth Toe or | Peripheral neural | Cutaneous | Joint |
| Finger 50 | connective tissue | nerves towards | mobilization |
| | | a major plexus. | subhold |

The subholds are the final phase of the treatment and are done in conjunction with the facilitation. As noted in the table above, the inflammation travels in five distinct pathways: The skin, the lymphatic sympathetic nerves, the arterial neural plexus, the major plexus nerves and the cutaneous nerves. The pathways all have to be functioning in each position. The identification of these pathways functioning through the INVF sensory technique is only valid for that position.

The assessment positions are positions of stretch. For example the sciatic nerve being stretched through a side lying hamstring stretching will place the afferent nerve blood supply to the five major areas of the sciatic nerve on stretch, and the response from the cerebellum to the toes' muscle tone will cue the clinician as to where the inflammation is within that position. In side lying, the first toe may have normal tone with absolute stiffness from the third or fourth toe and weak tone in the fifth and second toe.

This would indicate that the stretched sciatic nerve has nerve has inflammation associated with the arterial neural plexus and the lumbar and sacral plexus, and, accordingly, a combination of an arterial vascular hold and a joint mobilization subhold with L5 vertebral mobilization may be indicated to relieve the plexus inflammation and the arterial constriction associated with sympathetic inflammation for that nerve.

The cerebellum does indeed discriminate between the upper extremity and lower extremities. It differentiates as there is one neural pathway from the lower extremities and one neural pathway from the upper extremities. So in side lying position, the tone for the upper extremities will be unique and separate and indicate other areas of inflammation requiring facilitation and subholds then the lower extremity sciatic nerve which is being stretched, for instance.

The following is technical, detailed information on the cerebellum.

The cerebellum is located adjacent and posterior to the brainstem. It is connected to the brainstem via 3 peduncles: the superior, middle and inferior. The cerebellum consists of an outer cortex of gray matter with inner white matter and then inner nuclei, thus the cerebellum, in terms of depth can be divided into three zones. The cerebellum consists of an inner structure called the “Vermis” and two lateral masses much bigger called the cerebellar hemispheres.

The total cerebellum (vermis and hemispheres) can be divided into three lobes:

1. Archicerebellum is phylogenetically the oldest lobe and is found on the inferior aspect of the cerebellum. It consist of two “winged” shaped appendages and functions primarily with balance and

2. The anterior lobe, or paleocerebellum, lies anterior to the primary fissure.

3. The posterior lobe, or neocerebellum, is the largest of the 3 lobes and is posterior to the primary fissure.

The cortex of the cerebellum contains the following three layers: the outermost molecular layer, the Purkinge Layer, and the granular layer.

Each layer has special cells which assist with primarily inhibiting neural feedback from multiple tracts. The outermost layer, the Molecular Layer, has Basket and Stellate cells. These cells have multiple dendrites, each of which resembles a plant with outstretched branches. They interact with dendrites of the Purkinge cells and axons of granule cells.

The Purkinge layer has the only output cell the Purkinge cell which reaches deep into the vestibular or deep cerebellar nuclei and then project far into the outermost layer of the cortex, only in a sagital plane. This cell is primarily an inhibitory cell is excited by the Climbing Fibers which ascend from the inferior Olive. Purkinge cells make thousands of connections with other cells including Basket and Stellate cells.

The Granular layer has granule cells which start going straight and then form a “T” shape with the Parallel Fibers. These fibers extend throughout the cortex. Other cells in the Granular layer include: Climbing Fibers afferents, Mossy Fiber afferents which are a continuation of the dorsal spinocerebellar or cuneocerebellar.

As noted earlier the cerebellum is in communication with both the cerebrum and the brainstem through the cerebellar peduncles. The function of each peduncle is as follows:

The superior peduncle is comprised primarily of afferents with a few afferent pathways. Some of its tracts are involved with motor planning. See below for a description of important tracts that are run through the superior peduncle.

The middle peduncle is comprised of crossed afferents from contra-lateral pontine nuclei in the gray substance of the basal pons.

The inferior peduncle consists of afferent fibers. Its fibers arrive from the medulla (inferior olivary nuclei), the dorsal spino-cerebellar tract, the vestibular nerve and nuclei and the rostral spino-cerebellar tract.

The cerebellum integrates sensory feedback from the following tracts:

1. The ventral spino-cerebellar tract receives input from the lumbar and sacral golgi tendon organs. These fibers synapse in the intermediate Gray area and mediate pain, touch, Golgi tendon organ sensation, and pressure. This tract continues through the pons and enters through the Superior peduncle.

2. The rostral spino-cerebellar tract would be considered the upper extremity counterpart of the ventral spino-cerebellar tract. This tract enters the cerebellum through the inferior peduncle. This tract mediates information from Golgi Tendon organs plus pressure and pain sensors and enters the inferior peduncle of the cerebellum.

3. The dorsal spino-cerebellar tract receives afferents from golgi tendon organs which have already synapsed in the nucleus dorsalis, or Clark's nucleus. Primarily the levels will be between T1 to L2. This tract also enters through the superior peduncle.

4. The cuneo-spinocerebellar tract receives tracts from the accessory cuneate nucleus. This tract, like the rostral spinocerebellar tract carries information from the upper limbs.

### Table Summary of Afferent Tracts:

| | Levels Received | Primary sensation | Where it enters |
|---|---|---|---|
| Trace Name | Input from | utilized | the cerebellum |
| Ventral | Lumbar, lesser | Pain, touch, | Superior |
| spinocerebellum | extent sacrum | GTO, pressure | peduncle |
| Rostrospinocere | T1-L2 | Pressure, pain, | Inferior |
| bellar | | GTO | peduncle |
| Dorsal | Cervical spine | GTO | Inferior |
| spinocerebellar | | | peduncle |
| Cuneospinocere | C2-T5 (Utilizing | Muscle spindle, | Inferior |
| bellar | fasciculus | cutaneus touch, | peduncle |
| | cuneatus) | joint receptors | |

These important paths are utilized by the cerebellum and play a vital role in identifying neural ischemic paths. The hemispheres access the dentate and the interpose nuclei through Perkinge cells. The hemisphere pathway from the interposed nuclei includes projecting nerves to the contra-lateral parvocellular division of the red nucleus (the rostral aspect of the midbrain). The nerves then proceed through the rubroolivary tract, descend back to the inferior olivary complex (large nuclear part of the medulla oblongatata), and then provide a feed back loop to the dentate nucleus (deep cerebellar nuclei) and lateral zone of cerebellar cortex. The nerves from the dentate and interpose nuclei also project into the lateral and intralaminar nuclei of the thalamus from which they then relay information to the motor region of the ipsilateral frontal lobe. The thalamic connections to the frontal lobe make contact with the cortical efferent fibers which pass through pyramidal tract and project to the contra-lateral side of the body, beginning in the dentate and interposed nuclei and end on the same side of the body.

Please note the following table:

Path To Mapping or Cueing the Clinician As to The Location of Neural
Inflammation Through the INVF Sensory Technique (lower extremity)

1. Slowed afferent nerves responses from the arterial plexus project to the
ventral spinal cerebellar tract.
2. Decreased or slowed input is received into the cerebellum from the
ventral spinal-cerebellar tract.
3. The cerebellum lateral hemisphere first send information to the
interposed nuclei.
4. The interposed nuclei modifies coritico-spinal tract input in two ways.
They project to the contralateral parvo-cellular division of the red nucleus.
They then proceed to the rubro-olivary tract, descend back to the inferior
olivary complex, and then provide a feed back loop to the dentate nucleus
and lateral zone of cerebellar cortex.
5. The interposed nuclei also project into the lateral and intra-laminar
nuclei of the thalamus from which they then relay information to the motor
region of the ipsi-lateral frontal lobe. The thalamic connections to the
frontal lobe make contact with the cortical efferent fibers which pass
through pyramidal tract and project to the contra-lateral side of the body,
beginning in the dentate and interposed nuclei and end on the same
side of the body.
6. The modification of the pyramidal tract result in muscle tone
modification in conjunction with afferent nerve inflammation of the sciatic
nerve. The changed finger tone is what the clinician reads.

Other technical information is available below. However it needs to be noted that, with the facilitation and the subholds, the afferent information received results in a significant reduction in dysfunctional toe or finger muscle tone that is specific to that finger or toe and not to the other toes or fingers, indicating the improved afferent neural input to the cerebellum is resulting in specific tone increases in the fingers and toes as appropriate.

The Vermis also sends projections to the interposed nuclei through the superior peduncle to the magno-cellular division of the red nucleus on the opposite side. The magno-cellular division gives rise to axons of the rubro-spinal tract, which crosses the midline and enters the spinal cord on the same side as the nuclei. The rubro-spinal tract contributes to locomotion and coordinated movements of the extremities. The vermis also sends projections to the Fastigal nucleus, which in turn sends projections to the reticular and vestibular nuclei. These projections enter the spinal cord where they assist with controlling posture and balance.

It is widely believed that the hemispheres of the brain work with the tone in the extremities while the vermis works with the tone in the core. This belief is generally true, and supported by research to some extent and certainly repeated in commonly-used anatomy texts.

However, if the core is irritated or damaged (say, as a result of disk injury, midline visceral irritation, or head trauma) then the tones of the first finger (thumb) and first (big) toe will be strongly affected. If the paravertebral ganglia and associated structure have neural inflammation, the tones of the second finger and second toe will be strongly affected on the ipsi-lateral side. If the prevertebral ganglia are inflamed, then the tones of the third finger and third toe will be strongly affected. If the ipsi-lateral hip is inflamed (probably affecting the lumbar and sympathetic ganglia), then the tones of the fourth finger and fourth toe will be strongly affected. If there is irritation in the limbs, then the tones of the fifth finger and fifth toe will be strongly affected.

If a protruding object is placed against the back of a relatively healthy person, their first toe droops. If the object is moved laterally, towards the facet region and then towards the lateral arm, the adverse effect on their cerebellar vermis, namely, decreased sensory input from the core, can be observed to produce less tone guidance of the cortico-spinal tracts for the thumb and second finger.

The para-vermis, which controls in column next to the vermis and receives feedback from the more lateral core, responds to the cerebellum in similar manner, namely, with core sensory dysfunction with respect to ischemia developing in the nerve connective tissue that in turn affects the Golgi tendon organs, with impaired tone observable in the second and third fingers and toes.

The cerebellar hemispheres control the fifth finger. Irritation in the sensory nerves of an extremity that causes delayed sensation to the hemispheres will probably result in hyper-tonicity in the fourth and fifth fingers and toes.

While cerebellar hemisphere lesions are commonly said to cause extremity hypo-tonicity, studies also indicate that extremity hypo-tonicity also occurs in response to Vermis lesions.

Studies show that the Vermis is very active with second finger tapping. These types of discrete movements actually involve the vermis more then the hemispheres. While critics might point to the fact that second finger tapping might really be a product of the rubro-spinal tract, it could be noted that the rubro-spinal tract may or may not control discrete movements.

The interposed nucleus has not been completely mapped. Accordingly, it is still conceivable that the vermis can project from the interposed nucleus to the intra-lamina of the thalamus. For example, it is known that both the vermis and the hemispheres both project out to the interposed nucleus.

Joubert's Syndrome (significant lesion of the Vermis with no apparent effect on hemispheres) involves hypo-tonicity of the extremities with first finger and thumb weakness evident. Prehension problems on the part of the Joubert's Syndrome patient are also apparent.

In summary, not very much is known or completely understood about the cerebellum. Generalizations are made in neuro-anatomy text with little reference to the most up to date research simply because it is not in the scope of the text to present the ever-expanding knowledge of the complexity of the cerebellum and the questions that inevitably result from additional research.

In review, afferent nerve inflammation created by the joint position creates a slowing of the axo-plasmic flow, that is, a delay in the input into the cerebellum with a corresponding delay in the response. The result of this delayed response is a patterned inflammatory response which is position-specific and shown by the specific muscle tone in the MT or MP joints of the hand and foot. Note that the closer the inflammation is to the lower extremity, the greater will be the effect on the toes rather than the fingers; and the closer the inflammation is to the cervical spine, the greater will be the effect on the fingers.

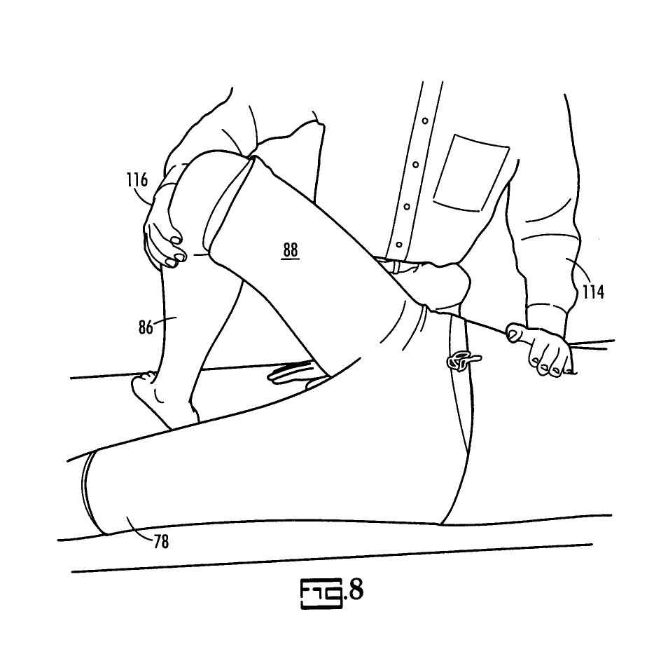

The second part of the treatment is the facilitation, which is illustrated in FIGS. 6 and 7. This part is as follows:

Facilitation is a proposed joint position that may increase the diameter of the lumen of the feeder vessels at its junction into the accompanying artery while en route to the epineurial connective tissue is as follows: A twisting motion of the wrist joint 60 of the patient 100 by the therapist 110 along with a combined abduction and flexion position of a joint force (See ranges in table below) such abducting the hip 62 in FIG. 6 and fully pronating the elbow 64 in FIG. 7, creates enough pull on the arterial end of the coiled nutrient vessel that the opening is larger in the nutrient vessel allowing for additional blood to be gathered by the nutrient vessel from the artery. The best positions for various joints to elicit this pressurizing of the blood are outlined in the table below. Please note that these positions appear to provide the fastest intra-neural circulation, however variations in joint position (increased or decreased flexion of the joint) may still produce some or most of the facilitation phenomena.

| | Best position to Produce Facilitated Blood flow through The |
|---|---|
| Joint | connective Tissue From The Accompanying Artery |
| Wrist | a. Wrist flexion to 60 degrees in pronation. |
| | b. Full wrist abduction with overpressure. Maintain |
| | these positions. |
| | c. Overpressure into wrist pronation as tissue and |
| | patient allows |
| Elbow | a. Elbow flexion between 60 and 105 degrees |
| | b. Overpressure with elbow fully pronated. Maintain |
| | these positions. |
| | c. Overpressure into elbow adduction after A and B are |
| | completed. |
| Shoulder | a. Shoulder flexed between 45 and 60 degrees. |
| | b. Full PROM of humeral head into humeral internal |
| | rotation. Maintain these positions. |
| | c. Overpressure into shoulder adduction after A and B |
| | are completed. |
| Hip | a. Hip flexed between 45 and 60 degrees |
| | b. Full PROM of hip into hip Internal rotation with |
| | overpressure. Maintain these positions. |
| | c. Overpressure into hip adduction after A and B are |
| | completed. |
| Knee | a. Knee flexed to around 90 degrees |
| | b. Full PROM of knee into internal rotation with |
| | overpressure. Maintain these positions. |
| | c. Overpressure into knee adduction after A and B are |
| | completed. |
| Ankle | a. Ankle plantar flexed between 30 and 45 degrees |
| | b. Full PROM of ankle into inversion with overpressure. |
| | Maintain these positions. |
| | c. Overpressure ankle into adduction after A and B are |
| | completed. |

Referring now to FIG. 2, feeder vessels from the arteries leading into the neural connective tissue are coiled and are located at irregular intervals along the nerve, but mostly at joints (see FIG. 2A).

The ranges noted in the accompanying table are meant as guides, but after working on patients while utilizing these holds, you can be certain the blood is being pressurized into the neural connective tissue will having a greater capacity to go into areas that are inflamed.

FIG. 7 shows the facilitation hold of the wrist to accelerate blood through the feeder vessels to the microvascular system. The patient's hand is flexed, externally rotated and pushed to obtain the wrist facilitation hold. At the same time, the elbow of the opposing hand is mobilized to induce flow of the pressurized blood to prefer the peripheral nerve microvasculature. A detailed example for the reason the facilitation hold works at the wrist is as follows. The wrist flexion creates traction of nutrient vessels that connect from the radial artery to the radial nerve, as well as from the ulnar artery to the ulnar nerve. The coil in the nutrient vessel has not been stretched taught (as illustrated in FIG. 2B) with this position alone to create a distortion of the opening in the opening between the radial artery and the nutrient vessel (as well as the ulnar artery and nutrient vessel). The wrist flexion at 60 degrees will allow the joint to move into wrist adduction and internal rotation in a great degree. Next the therapist adds wrist pronation which enables the feeder vessel to have additional stretch while continuing to provide increased angular tension at the arterial opening of the nutrient vessel. The final stretch involves wrist adduction with overpressure and creates final necessary distortional force upon the nutrient vessel arterial opening. Pressurized blood has now entered the microvascular system from the wrist due to the increased amount allowed in the same vessel verses before the facilitation hold. A continued hold will allow continued pressurized blood, in essence pressing the microvascular circulation blood flow farther and faster. The longer the hold from this one entrance area, the greater the chance more distal tissues will experience the phenomena of having pressurized blood enter into their connective tissue.

The reason the nutrient vessel is affected by simple joint movement is as follows. The nerve and its connective tissue are not as elastic as the accompanying artery, being obliged to move with the traction force being applied to them through the terminal branches of sensory, motor and axon nerves. Without elastin in nerve axons and only a small amount of elastin in the perineurium, the nerve axon and its connective tissue will respond to traction with sliding in space more readily and will be more resistant to deformation than the accompanying vascular system. Thus the nerve moves readily, the accompanying artery and nutrients do not but deform readily.

After the facilitation hold described has happened and is held by the practitioner, the pressurized blood will have entered into the connective tissue/capillary complex. Once the pressurized blood has entered the neural connective tissue arterial/capillary complex, it will push its way past ischemia resistance in the capillaries or arteries which would not without the increase in pressure push the blood through. The pressurized blood will then produce ATP as it is compressed by the narrowed capillary or arteriole lumen.

With capillary and arteriole deformation, mechanical deformation of red blood cells (RBC) will ensue. The deformation of RBC with the resultant ATP release was simulated in pushing RBC through filter paper with inside diameters of 12, 8 and 5 um. Another study involved mechanical deformation of red blood cells while pumping the blood through a microchip, better mimicking the in vivo stress placed on RBC. Mechanical deformation of red blood cells results in ATP production and initiates a cascade of events which stimulates nitric oxide to be produced from local platelets and endothelium. Nitric oxide has also been found to create vasodilatation by relaxing smooth muscles in nearby vasculature. The result of the increased local levels of nitric oxide would be an increase in RBC flow and oxygen delivery to ischemic neural connective tissue.

While deformation induced ATP has been shown by pumping blood through a microchip, it would seem theoretically possible to have the same cascade of events culminating in nitric oxide production and vasodilatation with manual deformation of nutrient vessels located around joints.

After the facilitation hold has occurred, additional volume of blood and the presence of ATP moving into the endothelium of the capillaries and arterioles of the epineurium (especially if ischemic) and would result in nitric oxide production in the neural connective tissue. The vascular system of the connective tissue will be challenged by the pressure created by the increased intrinsic flow of blood (due to NO production) and the improved circulation from the local feeder vessel due to the practitioner-induced nutrient vessel entrance enlargement. Now areas of token resistance due to partial ischemia, fibrosing, etc. may give way to the increased vascular pressure allowing for the restoration of blood flow in a particular anastamosing capillary.

Now the pressurized blood flow that will be discussed from this point forward will be the result of the facilitation and the increase in endoneurial and general microvascular enlargement due to ATP release. Pressurized blood as described here is more aggressive as a result of the facilitation resulting in blood to previously ischemic capillaries. Pressurized blood in the microvascular system travels faster in the microvascular capillaries and farther into the neural connective tissue than the blood did without the facilitation hold.

Once the facilitation is pressurizing the blood, the inflammation will not necessarily be addressed. There are multiple reasons why pressurize blood will not necessarily engage the Endoneurial capillaries. First of all, the oedema in the capillaries may be too great for a steady increase in pressurized, accelerated blood through the microvasculature. As noted earlier the oedema shuts off the transperineurial vessels and if the oedema is sufficiently extensive, the pressurized blood will stay more on the outside fascicle. The cause of peripheral nerve oedema has been outlined earlier but includes local peripheral nerve trauma or surgery. See Table below:

| | | Where | | Identifying |
|---|---|---|---|---|
| Nerve | | Inflammation | | finger or toe |
| Affected | Area Affected | Arrived from | How To Treat | with impaired tone |
| Sympathetic | Peripheral | Local peripheral | Lymphatic | 2 |
| nerves | nerve | nerve | hold, lumbar | |
| | connective | connective | treatment, | |
| | tissue | tissue | artiole hold or | |
| | | | combination | |
| Sympathetic | Lymphatic | Lymphnodes, | Lymphatic | 2 |
| nerve | nerve | centrally | subhold | |
| | connective | located, close to | | |
| | | vertebral | | |
| | | ganglia | | |
| Neural | Neural plexus | Hip or shoulder | Joint | 4 |
| plexus | connective | capsule, | mobilization | |
| | tissue | sacrum, T1-L3, | subhold, | |
| | | General | shoulder or | |
| | | peripheral nerve | hip subhold, | |
| | | inflammation | vertebral mob + | |
| | | | subhold | |
| Sympathetic | Arteriole | Paravertebral | Arteriole | 3 |
| nerves | connective | Viscera | subhold, | |
| | tissue | inflammation, | viscera | |
| | | peripheral nerve | subhold + | |
| | | ischemia | arterioles | |
| | Local nerve | Transperineurial | Wrist, joint | 5 |
| | oedema | occlusion | mobilization | |

Frank peripheral nerve inflammation involving a aberrant tone of the fifth finger. The transperineurial vessels being occluded and the blood coming from compensatory sources at an endoneurial level being reduced, the pressurized blood may have little chance of going into most of the transperineurial vessels and making its way into the endoneurial capillaries. However, pressurized blood has a significantly better chance of entering the inner chambers of the fascicle. However significant epineurial edema and tissue swelling would be the result of the treatment.

The second reason noted earlier is sympathetic vasoconstriction either due to distal microvasculature inflammation from the peripheral nerves affecting the sympathetic axon blood supply, or from the paravertebral ganglion. This creates additional vasoconstriction of arterioles, restricting the diameter of the vessel, for the pressurized blood to go through. The sympathetic capillary pathway ties together three separate systems. These systems are interchangeable and involve spine (paravertebral gangion), viscera/arterioles and lymphatics.

The arteriole plexus involves blood going through endoneurial capillaries of strictly sympathetic nerves that come from multiple nerves along an artery, or arterioles. One artery is innervated more distally by the peroneal nerve (the perineal artery) while the small cutaneous branches then connect to the sympathetic branches of the posterior tibial from the tibial nerve. As the artery continues upwards from the foot, the neural plexus is furnished sympathetic nerves from other peripheral nerves that connect at the popliteal foosa (the sciatic nerve innervating the popliteal artery) and the femoral artery (the femoral nerve innervating the femoral artery). All nerves have a common link in that they provide connective sympathetic nerves to these arteries. The endoneurial blood flow is congruous from these nerves along the artery, yet fed from separate peripheral nerves resulting in the opportunity to spread endoneurial blood between peripheral nerves, as well as a closed pathway for ischemia to go between peripheral nerves. With neural ischemia comes arteriole vasoconstriction, so vasoconstriction and ischemia distally on an artery can work its way proximally on an artery, and also work into a peripheral nerve.

The natural pathway of the arteries moves closer to the paravertebral ganglia, through the internal and external iliac arteries where at least some of the afferent nerves are that report to the cerebellum that result in modified tone to the third finger if it is inflamed. Due to the proximity of the viscera to the arteries at the paravertebral ganglia, inflammation of the viscera first affects the arteriole neural plexus previously described allowing inflammation to move downwards through the arteriole neural plexus and indirectly creating peripheral nerve vasoconstriction.

Hence a natural treatment for third muscle tone modification would be an arteriole subhold (shown below) along with visceral treatment and subpositions.

Lymphatic inflammation would be a path for sympathetic inflammation that would not be limited to a single peripheral nerve or paravertebral ganglion. If the lymphatics have been damaged the microvascular inflammation will spread into the sympathetic nerve microvasculature. The lymphatics are crucial for removal of fluid build up around a peripheral nerve and there sympathetic nerves are closely related to arteriole sympathetic nerves in proximity.

The same interconnectedness of the lymphatic sympathetic nerves from multiple peripheral nerves can be assumed with inflammation moving in this endoneurial pathway just as in the arterial nerve plexus pathway noted earlier. The tendency of the lymphatics, however, is to not extend towards the viscera, but to stay close to the spine, and a strong finger 2 position with aberrant tone can be treated with a lymphatic subhold as well as an arteriole subhold. Another subhold for the lymphatics would include skin tractioning as the lymph nodes and paths are superficial in nature.

Neural plexus inflammation involves all other forms of inflammation, but only to the extremity that is closest. Arteriole, transperineurial, lymphatic, peripheral nerve, and sympathetic nerves will all be affected by an interruption of the endoneurial blood supply of all axons occurring at the exit of major peripheral nerves going into the extremity. The inflammation at a plexus would be related to inflammation involving structures close to it.

The hip capsule, for instance, is innervated by the sciatic nerve and femoral nerve, according to Hilton's law. If sensory nerves into synovial tissue at this joint are inflamed, the inflammation would travel down the sensory nerves into the local neural plexus. The inflammation would then travel down into the major nerves that supplied the hip capsule and could then affect the neural plexus that produced the innervating nerves. The sacral plexus produces the sciatic nerve and comes from nerve roots L4-Co1. Sacral plexus inflammation would then be perpetuated by repeated sensory nerve inflammation of the hip capsule,

All manner of sensory and motor nerve connective tissue with endoneurial capillaries traverse through the neural plexus making this a local extremity wide problem. Lymphatic, sympathetic, sensory, motor nerve axons approach the peripheral nerves with limited blood flow predisposing that extremity to microvasculature hardships.

Treatment would involve hip capsular subholds and local vertebral mobilization with arteriole or vascular subholds. In addition, individual nerves while stretched and a joint mobilization subhold will increase the force of circulation through the intended plexus. Please note that the finger or toe affected will be the fourth toe or finger.

Treatment involving each type of inflammation is described and these subholds are necessary for eventual success. However, the present invention being a vascular technique, there will be some carryover between vascular pathways as the pressurized blood is induced with various subholds. This is due to the proximity of the neural structures and their connecting neural tissue and microvasculature. All holds are done with the facilitation hold being done at a distal location. Furthermore, a distortion or a stretch of the affected nerve needs to be done to ensure an end of the capillaries of the nerves that are specified are slightly enlarged.

The exact treatment sequence is as follows:

a. Stretch the nerve

b. Provide facilitation

c. Choose and administer the subhold until the aberrant muscle tone in the finger or toe monitored is cleared.

The first treatment is for the transperineurial inflammation. Joint mobilization of an extremity will have a tendency to keep the blood in peripheral nerve connective tissue with limited affect on the lymphatics and the arteriole sympathetic nerves. A joint mobilization will include a vascular induce of all the nerves that cross the joint.

If local vasoconstriction is found by doing a nerve stretch and then identifying a second toe- or finger-impaired joint tone, a lymphatic or arteriole subhold in that stretched position should address the inflammation of the local sympathetic nerves exposed with the nerve stretching.

The joint mobilization will provide separation between the axon and the neural connective tissue providing a distortion or traction of the transperineurial vessels. This will allow extrafascicular blood to enter into the major peripheral nerves' fascicles that are crossing the joint mobilized.

As this is a vascular hold, the effects of the hold will not be limited to the extremity being treated. The deep circulation induced will have a tendency to improve the deep peripheral nerve circulation in the entire system if held long enough. The improvement will naturally be most noticeable and more dramatic to the nerves that cross the joint that is being mobilized and to the nerve that is being placed on stretch during the treatment.

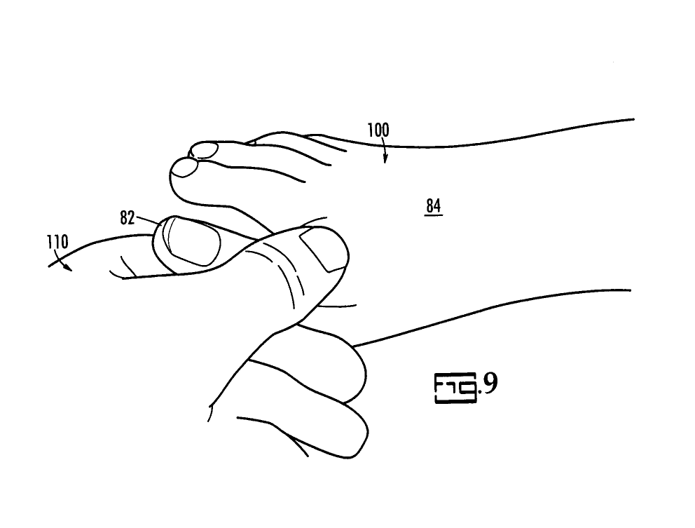

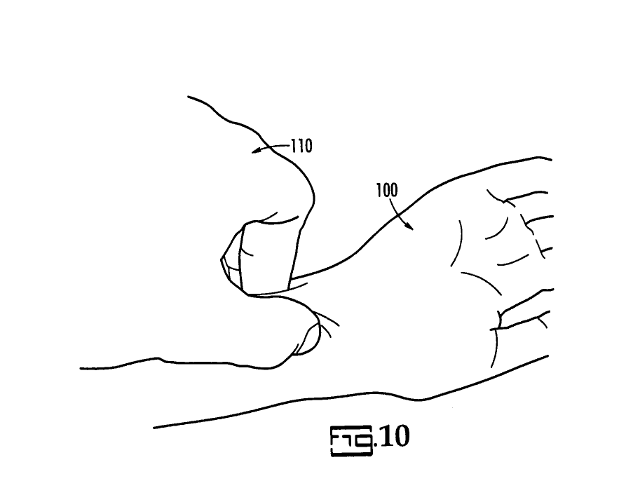

An example of this process would be the sciatic nerve that is stretched with a hamstring stretch, as illustrated in FIG. 8. While a facilitation hold is applied to the left leg of the patient 110 by the therapist 110 using straps if needed to pull and hold the patient's left foot into the facilitation position (not show), the left hand 114 of the therapist 110 mobilizes a rib of the patient 100 to encourage blood flow into the anterior ramus of T-12 and into the lumbar splanchnic nerve, and his right hand 116 mobilizes the tibia 86 proximal to the femur 88 of the right leg 78, the pressurized blood will naturally prefer go into the stretched hamstring. FIG. 9 illustrates the therapist 110 inducing a deep flow of blood into the peripheral nervous system of the patient 100 with an upward mobilization of the first MT joint 82 of the foot 84 of patient 110, as illustrated in FIG. 9.

The increased blood may meet sympathetic vasoconstriction in the epineurial lymphatics and the arterioles in the nerve fascicle. Even with increased endoneurial blood flow, the nerve may suffer unnecessary nerve swelling unless the arteriole and lymphatic inflammation are not treated properly.

The arteriole subhold is necessary and is very simple, yet necessary to access the ateriole neural vascular pathway that was described earlier. The three steps to treatment by the therapist 110 with the arteriole subhold are as follows:

a. Perform the facilitation

b. Stretch the intended nerve

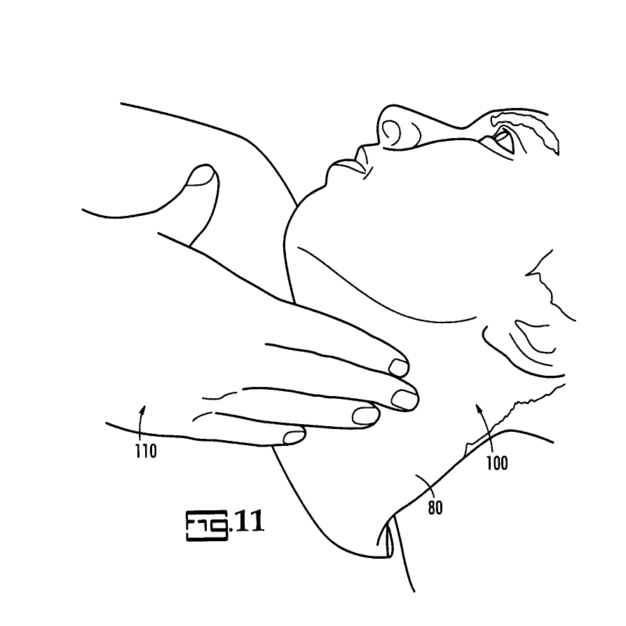

c. Grab the dorsalis pedis, or the ulnar artery or the radial artery of the patient 100 and provide a gentle squeezing, twisting pressure, as illustrated in FIG. 10, to affect the neural plexus in the arterial system with a rotation to ensure that there is a vascular distortion of the endoneurial capillaries over the nerves that are over the arteries.

This arteriole subhold enables pressurized blood to eliminate microischemia that prevents the symphathetic nerves from performing appropriately over the arterioles they are innervating. The impaired performance of the sympathetic nerves creates at most a local narrowing of the arterole lumen through a neural tetany but may not stimulate the smooth muscle at all, creating a general stasis of the blood going through the artery, thereby affecting the natural pumping mechanism.

With the nerve firing appropriately over the artery, increased blood pressurize now naturally occurs in at least the outer two layers of the neural connective tissue.

The pressurized blood will prefer to stay in the arteriole neural connective tissue pathway and proceed upwards through the microvasculature associated with the nerve into the viscera. The endoneurial capillaries are congruous along the course of the artery, and the blood does not know the source of the sympathetic nerves that it is entering. Thus multiple peripheral nerves are affected as they all connect at the arterioles (and the same is true with lymphatics). Multiple peripheral nerves are then addressed via means of the pressurized circulation being mobilized through their intersection at the artery neural connection tissue pathway.

The lymphatic system is very similar to the arteriole system with one exception. The best subhold applies where the most lymph nodes are, namely, the cervical area. So there are the steps to improving blood flow to the sympathetics involved with the lymphatic system:

1. Perform the facilitation

2. Stretch the nerve that is being targeted.

3. Have the patient do his own subhold by pushing the skin of his neck either towards or away from his ear.

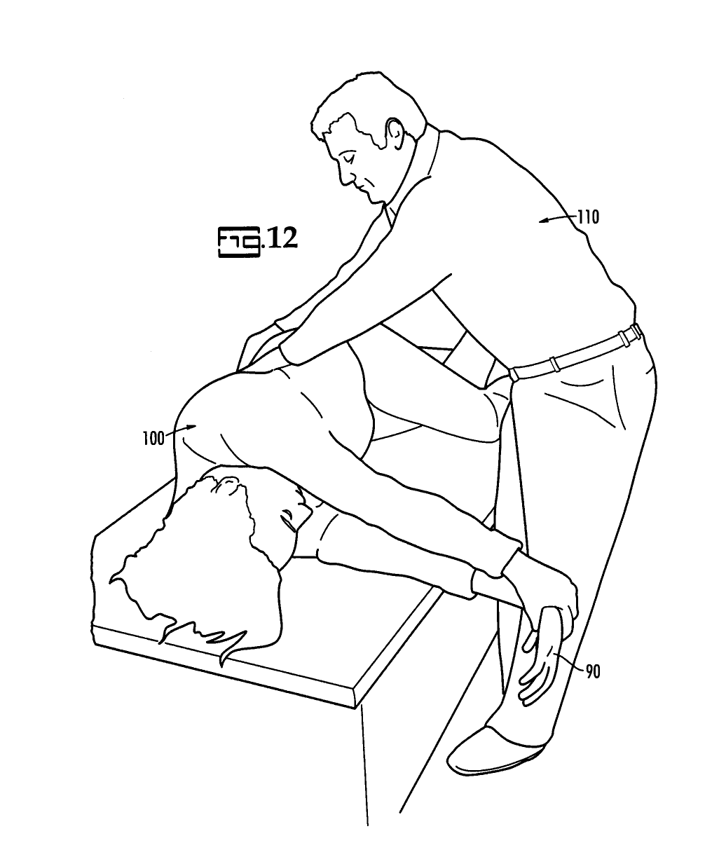

Skin stretching and vertebral mobilization of the patient 100 by the therapist 110 (pushing one vertebra on another and stretching the facet capsule) along with the lymphatic subhold will enhance the location and the affect of pushing of the skin on the neck 82 (see FIG. 11), as lymph nodes are located closer to the spine and the skin surface at the neck 80. A longer hold involving the lymphatics subhold (lateral traction of the hand) will result in the pressurized blood being induced into the inflamed lymphatic neural microvasculature throughout the extremity, the region featured, and ultimately the rest of the body.

From the local area involving the sympathetic neural connective tissue in the lymphatics, the blood will be induced to go into the distorted capillaries in the nerves next to the lymph nodes that are being pushed or stretched. In a broader sense this will enable the lymphatic system to perform at a higher level, especially in the target regions (areas being stretched) and better take away the swelling from the outside of the fascicle.

There has to be a close connection between the arterioles, the lymphatics and the peripheral nerve lymphatics and so there will be some carryover into arteriole improvement as well.

The peripheral nerve sympathetic inflammation is treated by either the arteriole or the lymphatic subhold, along with the stretch and the arteriole, or both combined along with the stretch and the facilitation technique.

The neural plexus is close to both the spine and a major hip capsule. The treatment involves doing one of the following three sequences:

Sequence 1: (a.) facilitation; (b.) joint mobilization to push on the capsule that is holding the two bones in place; and (c.) an arteriole subhold.

Sequence 2: emphasize major peripheral nerve blood flow simply by joint mobilization of each peripheral nerve that crosses the hip capsule joint.

Sequence 3: (a.) facilitation; (b.) vertebral mobilization to vertebra associated with neural plexus; and (c) arteriole subhold.

Please see the following table:

| Major | | Major peripheral | Major capsules to |
|---|---|---|---|
| Plexus | Vertebral Levels to | nerves to consider | Mobilize Close to |
| Targeted | Mobilize | Increasing blood | Affected Nerves |
| Brachial | C5-T1 | Median nerve, | Shoulder capsule |
| | | Radial nerve, | |
| | | Musculocutaneous | |
| | | Nerve, Ulnar nerve | |
| Lumbar | T12-L4 | Obturator, Femoral, | Hip capsule |
| Sacral | L5, Sacrum, coccyx | Sciatic, Superior | Hip capsule |
| | | and Inferior gluteal | |
| Coccyx | coccyx | Sensory around | Hip capsule |
| | | anus | |

Clinically the identification, facilitation and treatment principles have been born out with resulting positive patient outcomes including improved blood flow and decreased pain from inflammation. Case studies, such as the one below bear witness to the vascular nature of this technique. Peripheral neuropathy is clearly an ischemic condition demanding a reinstitution of blood flow in the neural microvasculature. Manual therapy has not, until now, attempted to systematically reinstitute blood into the peripheral nerve microvasculature. The following case study is an example of INVF successfully being used

History: A patient reports with the history of diabetic neuropathy for 2 years. The neuropathy started when he initiated chemotherapy for cancer, which is presently in remission. The reported a history of gout, but was not diabetic. Other history includes lumbar HNP with old permanent nerve damage at L5 nerve root. The patient reported numbness in three toes of his left foot and states he was unable to move his toes apart. He stated that the ball of the foot around the toes feels like a lump along with a general feeling of hypersensitivity over the affected foot. The patient reports he is taking LYRICA which is reducing his numbness and pain. However he still has the aforementioned symptoms. An objective examination was completed and is noted below:

ADL Reports: Unable to perform routine ADL's without pain. The patient reported he had to sell his business as he was unable to work without pain. The patient reported he “pretty much lies around.”

Objective:

SLS: Unable to complete SLS on the affected foot.

Palpation/Proprioception: Numbness with inability to ascertain with certainty whether the three toes of the left foot are up or down during proprioceptive testing.

Sharpened Rhombergs: Immediate sway with eyes closed.

Treatment Sequence: Intraneural Facilitation in various positions and holds in an effort to specifically target areas which appeared especially inflamed as identified through sensory testing.

Patient Reports During the First Treatment Sequence:

A typical treatment early in his therapy course starts with the facilitation hold. The patient would then report increased pressure and tingling which would be consistent with blood moving through the coiled feeder vessels, into the capillary vascular bed and past sensitized nervi nervorum signaling the tingling or pressure sensation. The longer the hold the more the sensation would spread which would be consistent with additional capillary fields signaling increased pressure continuing to force past closed endoneurial capillaries. The spreading tingling sensation would start and stop as the therapist starts and stops his hold, indicating that the “re-coiling” of the feeder vessel was effective. The spreading from extremity to extremity or into the head would illustrate the connection between the endoneurium of peripheral nerves and the pia matre of the central nervous system. The patient reported some swelling in his affected foot even though the exercises had not commenced which would be consistent with some water being “sheered” out of the blood stream and outside of the fascicle through the porous perineurium and epineurium.

The patient later reported burning, nausea and fatigue being consistent with bradykinin release (vasodilation) and TNF-a neurotransmitter released into the tissues, stimulating the outer tissues to react to the neurotransmitter. This extreme sensation went away after 24 hours with the patient having significant relief and decreased numbness in his feet. This also may indicate that the circulation was restored to the nerves affected by the treatment leaving them free from the neural transmitters. The goal of the therapist was to restore the total endoneurial blood volume of the nervous system connective tissue, which had decreased by space-occupying, inflamed and swollen, endothelium in the capillaries. Therapeutic exercises were started after his pain had significantly decreased and the patient was reporting that he was showing significant signs of progress.

The subjective reports during his treatment sequence were as follows:

At the start of the second treatment: The patient reports he had some increased feeling in the affected foot.

At the start of the third treatment: The patient reported significant improvement. The patient reportedly is walking better and is able to work around the house. After the start of the fourth treatment: The patient stated he was able to work around the house with minimal loss of balance.

At the start of the ninth treatment: States that he is better, with minimal discomfort with 10 minutes on treadmill. He is able to work on a tractor.

After the start of the twelfth treatment: The patient reported minimal to no foot numbness or pain and had no loss of balance with re-assessment. The patient reported his activities of daily living were nearly normal.

At the six-month follow up: The patient reports no regression or return of symptoms.

It will be apparent to those skilled in the art of physical therapy that many changes and substitutions may be made to the foregoing description of preferred embodiments without departing from the spirit and scope of the present invention, which is defined by the appended claims.

What is claimed is:

1. A manual method for increasing blood flow to the neurovascular system of a patient, said method comprising the steps of:
(a) manually increasing pressure on blood flowing through an artery of the vascular system of a patient near an area of the body of said patient selected to be re-vascularized, said artery having an opening formed therein for communicating with blood feeder vessels running from said artery to said neurovascular system; and
(b) temporarily and manually positioning a bone joint of said patient to enlarge said opening, whereby blood flows under increased pressure from said artery to said neurovascular system.

2. The method as recited in claim 1, wherein said bone joint is selected to be between 7.5 and 9.5 cm from said opening.

3. The method as recited in claim 1, wherein said bone joint is the wrist of said patient.

4. The method as recited in claim 1, further comprising the step of placing a strain on the neural connective tissue surrounding said artery to increase the supply of blood to nerves that regulate blood supply from said artery.

5. The method as recited in claim 4, further comprising the step of placing a strain on the neural connective tissue surrounding a second artery of said patient to increase blood supply to nerves that regulate the supply of blood from said second artery.

6. The method as recited in claim 5, wherein said second artery is a dorsal pedis artery, an ulnar artery or a radial artery.

7. The method as recited in claim 1, wherein said bone positioning step further comprises the steps of:
(a) flexing said bone joint to observe a range of motion for said bone joint;
(b) flexing said bone joint to a position midway through said range of motion of said bone joint;
(c) externally rotating said flexed joint towards an outside aspect of the body of said patient; and
(d) abducting said flexed and externally rotated joint outwards.

8. The method as recited in claim 1, wherein said bone joint positioning step step further comprises the steps of:
(a) flexing said bone joint through a range of motion to identify a position in said range of motion where said bone joint does not bend smoothly;
(b) flexing said bone joint to said position;
(c) externally rotating said joint towards an outside aspect of the body of said patient while holding said join in said position; and
(d) abducting said joint outwards while holding said flexed and externally. rotated joint.

9. The method as recited in claim 1, further comprising the step of assessing areas of the body of said patient to be re-vascularized.

10. The method as recited in claim 9, wherein said assessing step further comprises the step of observing muscle tone in the fingers of said patient to assess said areas of the body of said patient to be re-vascularized.

11. The method as recited in claim 10, wherein, when decreased tone is observed in a little finger, the extremities of said patient are revascularized.

12. The method as recited in claim 10, wherein, when decreased tone is observed in a ring finger, the neural plexus of said patient is revascularized.

13. The method as recited in claim 10, wherein, when decreased tone is observed in a middle finger, the visceral organs of said patient are revascularized.

14. The method as recited in claim 10, wherein, when decreased tone is observed in an index finger, the area lateral to the spine of said patient is revascularized

15. The method as recited in claim 10, wherein, when decreased tone is observed in said thumb, the spine of said patient is revascularized.

16. The method as recited in claim 9, further comprising the step of observing muscle tone in the toes of said patient to assess the location of inflammation in the body of said patient.

17. The method as recited in claim 16, wherein, when decreased tone is observed in a little finger, the extremities of said patient are revascularized.

18. The method as recited in claim 16, wherein, when decreased tone is observed in a ring finger, the neural plexus of said patient is revascularized.

19. The method as recited in claim 16, wherein, when decreased tone is observed in a middle finger, the visceral organs of said patient are revascularized.

20. The method as recited in claim 16, wherein, when decreased tone is observed in an index finger, the area lateral to the spine of said patient is revascularized

21. The method as recited in claim 16, wherein, when decreased tone is observed in said thumb, the spine of said patient is revascularized.

22. The method as recited in claim 9, further comprising the step of observing muscle tone in the fingers of said patient to assess areas of the upper body of said patient to be re-vascularized and in the toes of said patient to assess areas of the lower body of said patient to be re-vascularized.

23. The method as recited in claim 9, wherein said bone joint is ipsilateral to said area of said patient.

24. The method as recited in claim 9, wherein said bone joint is the wrist ipsilateral to said area.

25. A manual method of treating ischema is an area of a neurovascular system of a patient, said method comprising the steps of:
(a) assessing a patient in order to determine an area of the body of said patient to treat for ischema;
(b) manually increasing pressure of the blood flowing through an artery near said area;
(c) stretching muscles of said patient in said area;
(d) mobilizing joints of said patient in said area;
(e) tractioning skin of said patient in said area;
(f) distending viscera in said area; and
(g) distorting the vascular system in said area.

26. The method as recited in claim 25, wherein said assessing step further comprises the step of observing muscle tone in the fingers of said patient to assess areas of the upper body of said patient to be treated for ischema and in the toes of said patient to assess areas of the lower body of said patient to be treated for ischema.

27. The method as recited in claim 25, wherein said joint mobilizing step further comprises the steps of:
(a) flexing said bone joint to observe a range of motion for said bone joint;
(b) flexing said bone joint to a position midway through said range of motion of said bone joint;
(c) externally rotating said flexed joint towards an outside aspect of the body of said patient; and
(d) abducting said flexed and externally rotated joint outwards.

27. The method as recited in claim 25, wherein said joint positioning step further comprises the steps of:
(a) flexing said bone joint through a range of motion to identify a position in said range of motion where said bone joint does not bend smoothly;
(b) flexing said bone joint to said position;
(c) externally rotating said joint towards an outside aspect of the body of said patient while holding said join in said position; and
(d) abducting said flexed and externally rotated joint outwards.
